(19) United States
(12) Patent Application Publication
(10) Pub. No.: US 2025/0011519 A1
(43) Pub. Date: Jan. 9, 2025

(54) Thermoplastic Elastomers of High Vinyl Block Copolymer Compositions

(71) Applicant: Dynasol Elastómeros, S.A. de C.V., Altamira (MX)

(72) Inventors: Nerea Lago Juarez, Gajano (ES); Daniel Abraham Elizarrarás Maya, Tampico (MX); Sergio Corona Galván, Las Rozas (ES); Sergio Alberto Moctezuma Espiricueto, Altamira (MX); Luis Antonio Rodríguez Guadarrama, Madrid (ES)

(73) Assignee: Dynasol Elastómeros, S.A. de C.V., Altamira (MX)

(21) Appl. No.: 18/827,767

(22) Filed: Sep. 8, 2024

Related U.S. Application Data
(63) Continuation-in-part of application No. 17/987,065, filed on Nov. 15, 2022.
Application No. 17/987,065 is a continuation of application No. 17/147,520, filed on Jan. 13, 2021, now Pat. No. 11,542,355.
Application No. 17/147,520 is a division of application No. 16/094,752, filed on Oct. 18, 2018, now Pat. No. 10,899,864.

(51) Int. Cl. C08F 297/04

(52) U.S. Cl. CPC C08F 297/042; C08F 297/044; C08F 2810/00

(57) ABSTRACT

A styrenic block copolymer composition comprising a hydrogenated high vinyl block copolymer and/or a high vinyl styrene-ethylene/butylene-styrene (SEBS) copolymer is mixed with a thermoplastic resin to form a thermoplastic elastomer (TPE) composition. TPE compositions comprising hydrogenated high vinyl block copolymers with relatively high molecular weight compounded with polypropylene provide compounds with high flow properties, high clarity, low haze, which exhibit higher tensile strength and elongation at break than prior art compositions. High vinyl SEBS TPE compositions exhibiting high melt flow can be used in many applications, either as a neat polymer or in a compound, to produce medical devices including tubes, over molding applications for personal care, soft touch materials, automotive parts, blown film, dipped goods, materials with oxygen absorbing capability, oil gel compositions, radiation curable hot melt adhesive compositions, hot melt pressure sensitive adhesives, sealant formulations, elastic films, fibers and non-woven compounds.

### CROSS REFERENCE TO RELATED APPLICATIONS

This is a continuation-in-part application of U.S. patent application Ser. No. 17/987,065 filed on Nov. 15, 2022, which issued as U.S. Patent No., which is a continuation application of U.S. patent application Ser. No. 17/147,520 filed on Jan. 13, 2021, which issued as U.S. Pat. No. 11,542,355, which is a divisional application of U.S. patent application Ser. No. 16/094,752 filed Oct. 18, 2018, which issued as U.S. Pat. No. 10,899,864.

### BACKGROUND OF THE INVENTION

### 1. Field of the Invention

This present invention pertains to polar modifiers and processes for the synthesis of block copolymers of conjugated diene monomers and vinyl aromatic monomers by organolithium initiated anionic polymerization in aliphatic hydrocarbon solution. More particularly, the block copolymers produced with the polar modifier systems and processes of the invention advantageously incorporate very high levels of repeat units with pendant vinyl double bonds with low levels of vinylcyclopentane repeat units. Furthermore, invention enables the production of this kind of block copolymers at a fast polymerization rates, with narrow molecular weight distribution, having low content of randomized co-monomer repeat unit transitions among co-monomer blocks and employing less demanding cooling requirements to carry out polymerization than prior art. The invention also relates to thermoplastic elastomer (TPE) compositions comprising high vinyl block copolymers, articles prepared with the TPE compositions, and their end-use applications.

### 2. Description of the Related Art

Batch and semi-batch processes of alkyllithium initiated anionic polymerization in aliphatic hydrocarbon solution are versatile technologies to produce block copolymers of conjugated diene monomers, such as butadiene and isoprene, and vinyl aromatic monomers, such as styrene. This is because anionic polymerization and copolymerization of these types of monomers in aliphatic hydrocarbons occurs by a chain reaction mechanism that lacks termination, nor chain transfer reactions; polymerization mechanisms such as this are so called living polymerizations. Livingness of polymerization allows for multiple block sequence configurations, coupling schemes, end group functionalization chemistries and precise control of composition, molecular weight and molecular weight distribution. It is the objective of the present invention to provide new polar modifier systems specifically oriented to produce a distinctive kind of block copolymers that incorporate very high levels of pendant vinyl bonds, either by 1,2 or 3,4-addition of conjugated dienes. Many polar modifiers have been disclosed that can influence conjugated diene mode of addition towards this kind of microstructure, nevertheless, a very common drawback is that their capability to promote 1,2 or 3,4-addition drops significantly when polymerization temperature rises (Hsie, H.L.; Quirk, R.P., Anionic Polymerization: principles and practical applications, Marcel Dekker, 1996, page 217). Typical operating temperatures and limited heat removal capacity of industrial processes rule out most options of polar modifiers to get 1,2-vinyl contents higher than 80 wt % on a conjugated diene basis. Furthermore, various polar modifiers are prone to widen molecular weight distribution, due to chain transfer reactions (Hsie, H.L.; Quirk, R.P., Anionic Polymerization: principles and practical applications, Marcel Dekker, 1996, pages 188-189 and 217).

When polymerizing butadiene in the presence polar modifiers in amounts prone to get high vinyl contents (>70%) a fraction of the butadiene gets incorporated as repeats units of vinyl cyclopentane (VCP). It takes two butadiene molecules to get a single VCP repeat unit, and a single pendant double bond gets generated (see FIG. 1).

Luxton et al. (Polymer, Vol. 22, Issue 3, 1981, pages 382-386), explain that contributing factors to increase VCP content are: low butadiene concentrations during polymerization, use of high loadings of TMEDA and/or sodium counterion, as well as high polymerization temperature.

VCP content increases the glass transition temperature (Tg) of the polybutadiene segment, reducing the backbone flexibility and the low temperature properties, which affects the thermal and dynamic properties of the elastomer thermoplastic compositions of the block copolymers.

Present invention overcomes these obstacles enhancing productivity and control over block copolymer molecular attributes.

U.S. Pat. No. 7,851,558 provides examples of alkyllithium initiated anionic polymerization of high vinyl styrene-butadiene di-block and styrene-butadiene-styrene triblock copolymers employing polar modifiers N,N,N′, N′-tetramethylethylendiamine (TMEDA), ditetrahydrofurfurylpropane (DTHFP), dipiperidinocthane (DIPIP) and tetrahydrofuran (THF). 1,2-vinyl isomer contents reported were up to 78% for TMEDA, 84% for DTHFP, 96% for DIPIP and 54% for THF. Nevertheless, polymerization temperature was kept very low (25° C.), solvent to monomer mass ratio was rather high (about 12), and butadiene block polymerized in a time span of two hours.

U.S. Pat. No. 5,906,956 shows synergistic effect of low molecular weight alkoxides as sodium t-amylate (STA) and TMEDA that made possible homopolymerizing butadiene at 75° C., getting full conversion in 10 minutes and 83% vinyl incorporation. STA molar ratio to lithium was at least 0.5, and TMEDA ratio to lithium of at least 2. No experimental data is shown for synthesis of block copolymers of conjugated dienes and vinyl aromatic monomers, neither for VCP content of the polybutadiene synthesized.

U.S. Pat. No. 6,140,434 improved the feasibility of industrial operation of TMEDA/alkoxide recipe by using sodium mentholate (SMT). Main advantage of SMT over STA was from an industrial operative stand point. STA generates a volatile alcohol on contact with water on stripping stage, which is difficult to remove from solvent recycle and poisons anionic polymerization, whereas SMT does not affect purity of solvent recycle because of high boiling point of it, and of its menthol by-product. It is shown an example were a polybutadiene was prepared with 85% vinyl incorporation, using a solvent to monomer ratio about 8.09, TMEDA/SMT/Li molar ratio of 8/0.25/1, reaction temperature of 65° C., and reaction time of 10 minutes. No experimental data is shown for synthesis of block copolymers of conjugated dienes and vinyl aromatic monomers. No experimental data is shown for synthesis of block copolymers of conjugated dienes and vinyl aromatic monomers, neither for VCP content of the polybutadiene synthesized.

U.S. Pat. No. 8,138,270 shows TMEDA/sodium alkoxide/n-butyllithium polar modifier/initiator system is preparing high vinyl SBS type triblock copolymer. SBS copolymer with narrow weight distribution, with polydispersity index Mw/Mn of 1.06, was obtained with overall vinyl levels reported at 76.8% on a butadiene weight basis, with TMEDA/sodium t-pentoxide/n-butyllithium ratio of 1.8/0.055/1. Polymerization was performed in a semi-batch mode temperature, feeding butadiene to the reactor along a period of 100 minutes, while controlling reaction temperature at 70° C. Very similar result was obtained when replacing sodium t-pentoxide for sodium t-butoxide. It was shown that molecular weight distribution widening occurred to polydispersity index of 1.23 if sodium t-pentoxide/Li molar ratio was increased to 0.12. VCP content was not reported.

U.S. Pat. No. 7,740,760 takes advantage of TMEDA/SMT system to increase Tg of polybutadienes and random styrene-butadiene copolymers (SBR) by raising VCP content. When evaluating SBR synthesis using 4.9 moles of TMEDA per mole of active lithium in a continuous process reactor with residence time of 40 minutes and operating at 80° C., copolymer exhibited 10% VCP and 53% 1,2-vinyl levels (63 wt. % total vinyl content on a Bd basis). When adding to the recipe 0.2 equivalents of sodium t-amylate (STA) per mole of active lithium, VCP level gets to 23% while keeping 1,2 vinyl at 53% (76% total vinyl content on a Bd basis). Consequently, Tg raised from −31° C. in the low VCP containing SBR to −14° C. in the high VCP containing SBR.

Chinese patent 10845109 shows that batch polymerizing butadiene in the presence of n-butyllitium (n-BuLi) and N,N-dimethyl-tetrahydrofurfuryl amine (DMTHFMA) in cyclohexane solution, employing a DMTHFMA/n-BuLi ratio of 6/1, solvent to monomer ratio of approximately 7.7 and polymerization temperature of 60° C. gives 1,2-vinyl enrichment of 85%, but at expense of two hours of reaction time and broadening of molecular weight distribution toward polydispersity Mw/Mn index of 1.13. Attempts of coupling high vinyl polybutadienyllithium products with excess silicon tetrachloride get a maximum coupling efficiency of 66 wt. %. Amount of VCP content is not accounted in this patent. Neither is made evaluation in this patent of capability of the polar modifier system to prepare block copolymers of conjugated diene monomers and vinyl aromatic monomers.

U.S. Pat. No. 5,336,739 shows high vinyl polybutadiene and polyisoprene synthesis using ethyltetrahydrofurfuryl ether (ETE) as polar modifier, n-butyllithium initiator and hexane to monomer ratio of 4. For isoprene homopolymerization, 3,4+1,2 addition obtained was 70%, with ETE/Li molar ratio of 5 and reaction temperature controlled at 70° C. 1,2-vinyl content of polybutadiene polymerized under such conditions reached 76%; polybutadiene with 80% 1,2-vinyl enrichment was obtained when ETE/Li ratio was raised to 10, while reducing polymerization temperature to 60° C.

U.S. Patent Application No. 2012/0004379 A1 shows that binary polar modifier systems based on bis[2-(N,N-dimethylamino) ethyl] ether (BDMAEE) and sodium alkoxides, such as sodium 3,7-dimethyl octanolate (Na-DMO) or as sodium mentholate (SMT), are useful to get very high 1,2-vinyl contents when synthesizing polybutadiene and styrene-butadiene random copolymers (SBR) at rather high temperatures in the presence of n-butyllithium (n-BuLi). Examples are shown of polybutadiene with up to 94 wt % vinyl content when employing a BDMAEE/Na-DMO/n-BuLi molar ratio or 3/0.5/1, and of 93 wt % vinyl content when replacing Na-DMO in formulation with SMT. This polar modifier system was tested comparatively with other polar modifier systems in high vinyl polybutadiene and random styrene-butadiene copolymer, such as: BDMAEE alone, Na-DMO alone, TMEDA/Na-DMO, TMEDA/SMT, DTHFP/Na-DMO, and surpassed all of them in vinyl-enhancing capability. Nevertheless, it is also mentioned that final conversion after 60 minutes of polymerization at 80° C. is not complete; butadiene homo-polymerization with BDMAEE/Na-DMO/n-BuLi molar ratio or 3/0.5/1 reached 97% conversion, only. In addition, it is shown that Mooney viscosity rises considerably when increasing BDMAEE/n-BuLi of Na-DMO/n-BuLi ratios at fixed n-BuLi dosage. Lack of full conversion of monomer and high dependence of Mooney viscosity on polar modifier dosages are both signs of anionic active center poisoning by these polar modifiers. There is no report on this patent on VCP levels obtained, nor on the performance of polymer anions towards coupling agents or other means to prove livingness of the polymerization. There is not mention on this patent application on usefulness of this polar modifier systems for synthesis of block copolymers of conjugated diene monomers and vinyl aromatic monomers.

Kozak et al. (International Journal of Polymer Characterization, Vol. 20, 7,(2015), 602-611, and International Journal of Polymer Characterization, Vol.21, 1, (2016), 44-58) compared performance of various polar modifier systems in a 15% butadiene solution polymerization at 70° C.: DTHFP, DTHFP/SMT, TMEDA/SMT, 2,2-bis(2,2-dimethylaminocthyl)ether (BDMAEE) and BDMAEE/SMT, among various others systems. It was found that BDMAEE/SMT was the most powerful polar modifier system in terms of 1,2-vinyl enhancement in butadiene lithium initiated polymerization, reaching about 90% vinyl content. BDMAEE alone had poor performance, reaching about 70% vinyl content but with poor conversion after 2 h of reaction. Another noteworthy finding was that combining DTHFP and SMT had a detrimental effect on vinyl content level when compared to DTHFP alone.

Halasa and Hsu, (Polymer, 43, (2002), 7111-7118), point out that any kind of alkoxide is equally effective to speed up conjugated diene reaction and to obtain high vinyl contents when combined with TMEDA. Again, in the case of butadiene it is reported vinyl levels of 82-83 while polymerizing butadiene at 75° C. in the presence of TMEDA/Li mole ratio greater or equal to 2 and alcoxide/Li ratio equal or greater than 0.5. It was reported higher Tg values, indicative of higher vinyl contents, and higher butadiene polymerization rates, when combining SMT with TMEDA than when using systems based on ethyltetrahydrofurfuryl ether/SMT (ETE, a molecule with two ether moieties). It is worthwhile noticing that vinyl contents reported throughout their studies include 2 to 6% of VCP.

It is known that high vinyl block copolymers of the prior art find application in a variety of high end value fields, such as precursors for high flow SEBS copolymers as mentioned in EP1730201 and U.S. Pat. No. 7,439,301. Such kind of SEBS are particularly useful for the manufacture of articles where it is required to avoid the usage of plasticizers and low molecular weight additives that could potentially migrate and affect use, haptics and/or health of users. Moreover, high vinyl content in SBS copolymer precursor allows the possibility to produce SEBS exhibiting high compatibility with polypropylene as mentioned in European patent EP1002813, making them very useful for the manufacture of elastic films, fibers and non-wovens compounds; coupled high vinyl SBS copolymers finds use as precursor for SEBS intended for soft elastomeric films; precursors for SEBS copolymers used in oil gel compositions for use in cable filling compounds, as shown in European patent EP0822227; precursors for SEBS intended for sealant formulations, as shown in U.S. Pat. No. 5,777,043; precursors of SEBS that provide high clarity and improved mechanical properties when compounded with polyolefins, as shown in U.S. Patent Application No. 2010/0331465 A1; for the formulation of polypropylene compositions with oxygen absorbing capability, as in U.S. Patent Application No. 2012/0252922 A1; for use in radiation curable hot melt adhesive compositions, as shown in U.S. Pat. No. 6,486,229; for use in hot melt pressure sensitive adhesives, as in U.S. Patent Application No. 2015/0191637 A1.

However, it would be desirable to have a thermoplastic elastomer (TPE) composition of high vinyl block copolymer, which could be easily compounded, providing a compound with high flow properties, high clarity, low haze, but maintaining or enhancing the mechanical properties.

### SUMMARY OF THE INVENTION

It has been unexpectedly found that a polar modifier system based on the ternary blends DTHFP/BDMAEE/SMT, ETE/BDMAEE/SMT, TMEDA/BDMAEE/SMT and DMTHFMA/BDMAEE/SMT are particularly advantageous to produce block copolymers of conjugated diene monomers and vinyl aromatic monomers. Very high levels of 1,2-vinyl and 3,4-vinyl bond addition of the conjugated diene monomer, low vinylcyclopentane contents, unimodal narrow molecular weight distribution, and low level of randomized repeat unit incorporation can be obtained. Furthermore, the invention enables producing this kind of copolymers at competitive production rates and with lower sensitivity of degree of 1,2-vinyl and 3,4-vinyl addition towards temperature than in previous technologies.

Even though it can be found in technical literature that BDMAEE/SMT system can be used to produce high vinyl polybutadiene at fast polymerization rates with low sensitivity of attainable vinyl content against polymerization temperature, our evaluations show that this polar modifier is not capable to produce block copolymers of vinyl aromatic monomers and conjugated diene monomers that fulfill simultaneously the requirements of unimodal narrow molecular weight distribution and low degree of randomized comonomer incorporation and competitive polymerization speed. There is a critical concentration level of this polar modifier in a formulation above which it produces problems of molecular weight widening, and even bimodal molecular weight distributed copolymers; when attempting to produce triblock SBS copolymer using BDMAEE/SMT at high loadings it is produced a blend of low molecular weight diblock copolymer with high molecular weight triblock copolymer. Below such critical loading level, BDMAEE/SMT is capable to produce block copolymers with narrow molecular weight distribution, nevertheless polymerization rate becomes rather slow; this has the concomitant disadvantage of producing block copolymers with rather high levels of randomized comonomer incorporation.

It was found that a polar modifier system that includes ditetrahydrofurfurylpropane (DTHFP) with BDMAEE and SMT exhibits a number of improvements compared to prior art systems. DTHFP is one of many compounds represented by formula (I) below. Although the experimental work has not yet been completed, it is reasonable to believe that many other compounds represented by formula (I), if not all of the compounds, can be substituted for DTHFP with similar results expected.

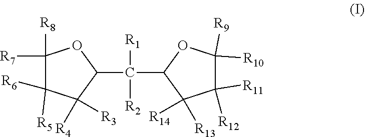

wherein R₁ thru R₁₄ independently are —H or —CₙH₂ₙ₊₁ groups, wherein n=1 to 6.

It was found that a polar modifier system that includes ethyltetrahydrofurfuryl ether (ETE) with BDMAEE and SMT exhibits a number of improvements compared to prior art systems. ETE is one of many compounds represented by formula (II) below. Although the experimental work has not yet been completed, it is reasonable to believe that many other compounds represented by formula (II), if not all of the compounds, can be substituted for ETE with similar results expected.

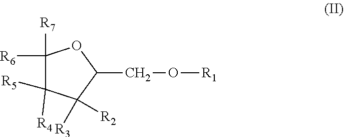

wherein R₁ is a —CₙH₂ₙ₊₁ group, wherein n=1 to 6; and
wherein R2 thru R7 independently are —H or —CₙH₂ₙ₊₁ groups, wherein n=1 to 6.

1. It was found that a polar modifier system that includes N,N,N′,N′-tetramethyl ethylenediamine (TMEDA) with BDMAEE and SMT exhibits a number of improvements compared to prior art systems. TMEDA is one of many compounds represented by formula (III) below. Although the experimental work has not yet been completed, it is reasonable to believe that many other compounds represented by formula (III), if not all of the compounds, can be substituted for TMEDA with similar results expected.

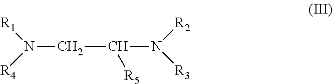

wherein R1 to R4 independently are —CH₃ or —CH₂CH₃ groups; and
wherein R5 is a —H or a —CₙH₂ₙ₊₁ group, wherein n=1 to 2.

2. It was found that a polar modifier system that includes tetrahydrofurfuryl-N,N-dimethylamine with BDMAEE and SMT exhibits a number of improvements compared to prior art systems. Tetrahydrofurfuryl-N,N-dimethylamine is one of many compounds represented by formula (IV) below. Although the experimental work has not yet been completed, it is reasonable to believe that many other compounds represented by formula (IV), if not all of the compounds, can be substituted for tetrahydrofurfuryl-N,N-dimethylamine with similar results expected.

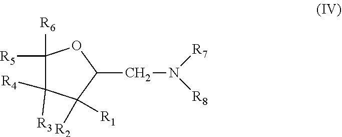

wherein R1 to R6 independently are —H or —CₙH₂ₙ₊₁ groups, wherein n=1 to 6; and
wherein R7 and R8 independently are —CₙH₂ₙ₊₁ groups, wherein n=1 to 2.

3. It was found that a polar modifier system that includes DTHFP, ETE, TMEDA and/or tetrahydrofurfuryl-N,N-dimethylamine with BDMAEE and SMT exhibits a number of improvements compared to prior art systems. BDMAEE, which is bis[2-(N,N-dimethylamino)ethyl] ether, is one of many compounds represented by formula (V) below. Although the experimental work has not yet been completed, it is reasonable to believe that many other compounds represented by formula (V), if not all of the compounds, can be substituted for BDMAEE with similar results expected.

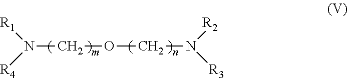

wherein m=1 to 2, n=1 to 2, and
wherein R1 to R4 independently are —CₙH₂ₙ₊₁ groups, wherein n=1 to 6.

This invention allows to produce purer SBS triblock copolymers than current Lewis base systems used to produce high-vinyl content SBS. Pure triblock SBS exhibit outstanding elastic performance compared with SBS having less purer blocks or to SBS exhibiting broader molecular weight distribution.

This invention allows to produce SEBS having higher vinyl content than conventional methodologies. High vinyl content combined with low styrene content allows SEBS to exhibit flow even with relatively high molecular weight. High melt flow combined with high vinyl content allow SEBS to be more compatible with polyolefins, particularly with polypropylene, blends than are used advantageously over PVC in health-related applications. Thermoplastic elastomer (TPE) compositions of high vinyl content SEBS with polypropylene exhibit higher tensile strength and elongation at break than prior art compositions. Styrenic block copolymer compositions comprising at least one high vinyl block copolymer of the present invention provide an improved balance of rheological (i.e., melt flow rate) and mechanical properties (i.e., tensile strength and elongation). Moreover, SEBS exhibiting high melt flow can be used in many applications, either as a neat polymer or in a compound, including injection molding to produce medical devices, over molding applications for personal care, soft touch materials, and automotive parts, blown film, dipped goods, materials with oxygen absorbing capability, piezoresistive ink compositions, battery cell binder compositions, oil gel compositions, radiation-curable hot melt adhesive compositions, hot melt pressure sensitive adhesives, sealant formulations and elastic films, fibers and non-wovens compounds.

### BRIEF DESCRIPTION OF THE DRAWINGS

A better understanding of the invention can be obtained when the detailed description of exemplary embodiments set forth below is considered in conjunction with the attached drawings in which:

FIG. 1 provides a graphic representation of the molecular structure of several polydiene microstructures;

FIG. 2 provides a graphic representation of the molecular weight distribution for Example 2 and Comparative Examples C1 and C2;

FIG. 3 provides a graphic representation of the molecular weight distribution for Example 3 and Comparative Examples C7 and C8;

FIG. 4 provides a graphic representation of the molecular weight distribution for Examples 13 and 14 and Comparative Examples C11 and C12; and

FIG. 5 provides a graphic representation of the molecular weight distribution for Example 15 and Comparative Example C13.

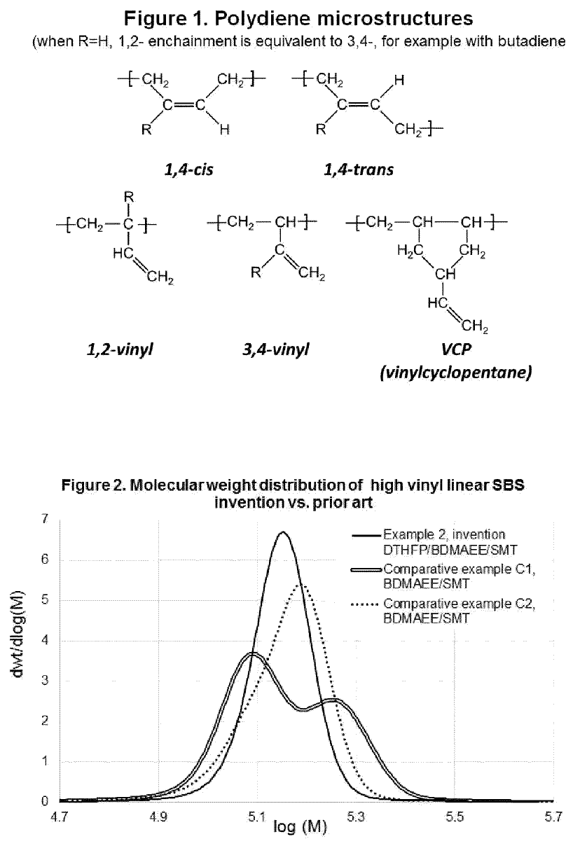

### DETAILED DESCRIPTION OF THE EXEMPLARY EMBODIMENTS

The anionically polymerized polymers can be made by any suitable method known in the art, such as those described in U.S. Pat. No. 3,281,383 and U.S. Pat. No. 3,753,936. In these methods, the anionically polymerized polymers are made by contacting anionically polymerizable monomers with an organolithium compound as an initiator. The preferred class of these compounds can be represented by the formula RLi wherein R is a hydrocarbon radical selected from the group consisting of aliphatic, cycloaliphatic, and aromatic radicals containing from 1 to 20 carbon atoms, although higher molecular weight initiators can be used. Many anionic polymerization initiators are well known and commercially available. Monofunctional organolithium compounds, such as butyllithium, are examples of commonly used initiators. Specific examples of these initiators include methyllithium, ethyllithium, tert-butyllithium, sec-butyllithium, n-butyllithium, n-decyllithium, isopropyllithium, eicosyllithium, cycloalkyllithium compounds, such as cyclohexyllithium, and aryllithium compounds, such as phenyllithium, naphthllithium, p-toluyllithium, 1,1-diphenylhexyllithium, and the like. Monofunctional organolithium compounds substituted with protected polar functional groups may also be used as initiators for anionic polymerization.

The amount of initiator varies depending upon the desired molecular weight of the anionically polymerized polymer. Number average molecular weights between about 20,000 and 500,000 can be obtained by adding about 0.20 to 5.0 millimoles of the RLi initiator per mole of monomers corrected by the factor 100/(MW of monomer).

Multifunctional organolithium initiators may also be used as initiators to prepare branched and radial copolymers with a desired functionality range of 2 to about 30 anionically polymerized polymers chains per initiator molecule. Multifunctional organolithium initiators are readily prepared by direct addition reaction of a stoichiometric amount of a monofunctional organolithium compound to a polyvinyl compound such as 1,3-diisopropenyl benzene, 1,3,5-triisopropenyl benzene, 1,3-bis(1-phenylethenyl)benzene, 1,3,5-tris(1-phenylethenyl)benzene, 1,3-divinylbenzene, 1,3,5-trivinylbenzene, and the like. Oligomeric polyvinyl compounds may be used to prepared multifunctional organolithium initiators with high functionality. Monofunctional organolithium compounds, such as butyllithium, are examples of commonly used initiators for the above addition reaction. Specific examples of these commonly used initiators include tert-butyllithium, sec-butyllithium, and n-butyllithium. Monofunctional organolithium compounds substituted with protected polar functional groups may also be used to prepare multifunctional organolithium initiators. Multifunctional organolithium compounds may be combined among them and/or with monofunctional organolithium compounds to partially initiate anionic polymerization with the multifunctional organolithium compound. The partial initiation is achieved by controlling the stoichiometric ratio of multifunctional initiator to monofunctional initiator.

Anionic polymerization is typically carried out in inert hydrocarbon solvents at relatively low temperatures under vacuum or an inert atmosphere with highly purified reagents in order to prevent the premature termination of the polymerization reaction. The anionic polymerization reactions may take place in a variety of organic solvents. Examples of suitable solvents include, but are not limited to, pentane, hexane, heptane, octane, cyclopentane, cyclohexane, cycloheptane, benzene, naphthalene, toluene, xylene, methyl ether, methyl ethyl ether, diethyl ether, tetrahydrofuran, acetone, methyl ethyl ketone, and mixtures thereof. Cyclohexane in particular, is well suited for use as the solvent in anionic polymerizations.

The anionic polymerization is normally carried out at temperatures in the range from −100° C. to 150° C., preferably between −75° C. and 75° C. Normally 50 to 90% by weight of a reaction solvent is used to control the viscosity inside the reaction zone, preferably 70 to 85%. Typical residence times for anionic polymerization vary depending on the reaction temperature and initiator level between 0.1 and 5 hours, preferable from 0.2 to 2 hours.

Suitable conjugated dienes for use in building the anionically polymerized polymers of the present invention include, but are not limited to, 1,3 butadiene, isoprene, 1,3-pentadiene, methylpentadiene, phenylbutadiene, 2,3-dimethyl-1,3-butadiene, 2,4-hexadiene, 1,3-hexadiene, 1,3-cyclohexadiene, 3,4-dimethyl-1,3-hexadiene, 1,3-octadiene, 4,5-diethyl-1,3-octadiene, myrcene, farnesene and the like. Other anionically polymerizable monomers that may be used in the production of the anionically polymerized polymers include, but are not limited to, monovinyl aromatic monomers, such as styrene and styrene derivatives including 3-methylstyrene, α-methyl styrene, p-methyl styrene, α,4-dimethylstyrene, t-butyl styrene, o-chlorostyrene, 2-butenyl naphthalene, 4-t-butoxystyrene, 3-isopropenyl biphenyl, 4-vinylpyridine, 2-vinylpyridine and isopropenyl naphthalene, 4-n-propylstyrene. Functionalized conjugated diene monomers and functionalized monovinyl aromatic monomers that may be used in the production of the anionically polymerized polymers include, but are not limited to, silylated monomers, and the like.

In some embodiments of the methods provided here, the anionically polymerized polymers undergo total or partial coupling to prepare branched and radial anionically polymerized polymers. Partial coupling means that a portion of the total living anionically polymerized polymer chain-ends undergo coupling with coupling agents. The coupling agents desirably couple between 2 and 30 anionically polymerized polymer chains, although coupling agents capable of coupling a greater number of chains may also be employed. Suitable coupling agents for use in the total or partial coupling step include, but are not limited to, epoxidized soybean oil, divinylbenzene, tin halides, silicon halides, functionalized tin compounds, functionalized silicon compound such as a silane compound and functionalized oligomeric compounds such as the ones listed in U.S. Pat. No. 7,517,934. The entire disclosure of U.S. Pat. No. 7,517,934 is incorporated herein by reference. Silicon tetrachloride and tin tetrachloride are specific examples of suitable coupling agents, with silicon tetrachloride being particularly well-suited for this application. The partial coupling is achieved by controlling the stoichiometric ratio of coupling agent to living polymer. The partial coupling may provide a polymer blend with desired properties.

Organometallic compounds of different metals from Groups IIa, IIb and IIIa, including magnesium, zinc and aluminum, may be used as polymerization rate modifiers when mixed with alkyllithium initiators. Specific examples of suitable polymerization rate modifiers are dibutyl magnesium, diethyl zinc and tricthyl aluminium. The polymerization rate modifiers may be used to control the temperature profile of polymerization. The polymerization rate modifiers contribute to control a polymerization step in either isothermal mode for a pre-established residence time or quasi-adiabatic mode up to a peak temperature.

In some embodiments of the methods provided here, the anionically polymerized polymers are polymerized in batch, programmed-batch and/or semi-batch processes. In additional embodiments of the methods of the present invention, the anionically polymerized polymers may be prepared in continuous and/or semi-continuous mode. The anionic polymerization of the anionically polymerized polymers may take place in situ i.e., in a single reaction zone, or may take place in multiple reaction zones. The former design tends to favor faster reactions while the latter design may be preferred when specially controlled polymerization reactions are desired. In some embodiments, a reaction apparatus having two or more reaction zones (e.g., reaction chambers) may be employed.

As one of skill in the art would recognize, the described synthesis of the anionically polymerized polymers can occur in a reaction setting comprising either a batch, a semi-continuous or a continuous process operated at temperatures, solvent ratios and stream flow rates necessary to reach the described residence time and stoichiometry conditions.

In some embodiments, the process of the invention further comprises a hydrogenation step of high vinyl block copolymer compositions to obtain the hydrogenated high vinyl block copolymers (e.g., high vinyl SEBS) of the present invention. Selective hydrogenation may be performed by any known prior art method. The hydrogenation process of the invention selectively saturates conjugated diene repeat units and leaves the aromatic unsaturation in the rubber intact. The hydrogenation step can be achieved by contacting the deactivated rubber solution in a hydrocarbon solvent with pressurized hydrogen and a titanocene compound (e.g., a titanium metallocene catalyst in tetrahydrofuran), including but not limited to structures such as Cp2Ti(PhOCH3) 2 or Cp2Ti(CH2PPh2)2, as disclosed in U.S. Pat. No. 5,321,175, U.S. Patent No. 5,985,995, U.S. Pat. No. 9,211,532 B2, European patent EP 2,489,688 B1 and PCT patent application WO 2010/149812 A1, which are incorporated by reference.

In thermoplastic elastomer (TPE) compositions of the present invention, the components of the TPE compositions may be blended by any known method as disclosed in U.S. Pat. No. 6,310,138 B1 and European patent EP 3,325,519 B1, which are incorporated by reference. A styrenic block copolymer composition comprising at least one high vinyl SEBS or hydrogenated high vinyl block copolymer of the present invention, can be first mixed with a thermoplastic resin to form the TPE composition. The thermoplastic resin is preferably a polyolefin-based polymer. The polyolefin-based polymer is selected from the group consisting of polypropylene, polyethylene, ethylene/□-olefin copolymer, ethylene/propylene copolymer, ethylene/propylene/diene terpolymer, propylene/1-butene copolymer, propylene/ethylene/□-olefin terpolymer, impact propylene/ethylene copolymer, and their recycled equivalents, including post-consumer and/or post-industrial recycling materials, or a mixture of the foregoing. The styrenic block copolymer composition, comprising at least one high vinyl block copolymer of the present invention, may also comprise a commercially available styrenic block copolymer. Optionally, stabilizers, fillers, colorants, cross-linking agents (if any) and other appropriate additives may also be added. Similarly, a styrenic block copolymer composition comprising at least one high vinyl SBS or unhydrogenated high vinyl block copolymer of the present invention, can be first mixed with a thermoplastic resin to form the TPE composition. The thermoplastic resin is selected from the group consisting of polystyrene, polypropylene, polyethylene, ethylene/□-olefin copolymer, ethylene/propylene copolymer, ethylene/propylene/diene terpolymer, propylene/1-butene copolymer, propylene/ethylene/□-olefin terpolymer, impact propylene/ethylene copolymer, and their recycled equivalents, including post-consumer and/or post-industrial recycling materials, or a mixture of the foregoing. The styrenic block copolymer composition, comprising at least one high vinyl block copolymer of the present invention, may also comprise a commercially available styrenic block copolymer. Optionally, stabilizers, fillers, colorants, cross-linking agents (if any) and other appropriate additives may also be added to the TPE composition of the present invention.

In a preferred embodiment of the present invention, the TPE composition comprises less than 60 wt. % of the hydrogenated styrenic block copolymer composition according to the invention, based on the total weight of the TPE composition. The TPE composition of the invention may further comprise additives common to the skilled person, such as heat stabilizers, antioxidants, fillers, crosslinking agents, colorants and other additives in small amounts, typically up to 10 wt. %, preferably less than 5 wt. %, based on the total weight of the TPE composition.

Thermoplastic resins are used in TPE compositions to improve the appearance of the finished product, whilst also adjusting the hardness and dimensional stability. Preferably, the thermoplastic resin is a polyolefin such as polypropylene, homopolymer, random, block or heterophasic propylene copolymer (RAHECO) as disclosed in U.S. Pat. No. 9,944,780 B2, which is incorporated by reference. More preferably, the thermoplastic resin is a polypropylene homopolymer with a melt flow higher than 1.0 g/10′ at 230° C. and 2.16 kg, such as ISPLEN PR-590, which is commercially available by Repsol.

In a preferred embodiment of the present invention, the amount of thermoplastic resin in the TPE composition is less than 90 wt %, based on the total weight of the TPE composition. In a more preferred embodiment of the present invention, the amount of thermoplastic resin (i.e., polyolefin such as polypropylene) in the TPE composition is at least 50 wt. %, based on the total weight of the TPE composition. According to a further embodiment, the amount of thermoplastic resin is between 10 and 100 phr, wherein “phr” means “parts per hundred of rubber”, the rubber being the hydrogenated styrenic block copolymer composition, e.g. high vinyl SEBS. In a further embodiment the amount of thermoplastic resin is between 15 and 75 phr.

Antioxidants typically used are hindered phenols. Exemplary antioxidants include those commercially known as IRGANOX® 1010, IRGANOX® 1076, and IRGANOX® 1330 from Ciba Specialty Chemicals. These antioxidants trap free radicals formed upon heating in the presence of oxygen and prevent discoloration or changes in the mechanical properties of the TPE composition.

According to an embodiment of the invention, TPE composition of the invention comprises 100 phr of hydrogenated styrenic block copolymer composition, between 10 and 100 phr of thermoplastic resin, preferably between 15 and 45 phr, optionally between 0 and 300 phr of filler and optionally between 0 and 25 phr of other additives, wherein “phr” means “per hundred parts of rubber”, the rubber being the hydrogenated styrenic block copolymer composition comprising at least one high vinyl SEBS of the present invention.

Examples of shaping methods useable for forming articles from the TPE composition of the present invention include injection molding, extrusion, compression molding, blow molding, rotational molding, and the like. It is within the scope of the invention to produce a wide range of articles of manufacture from the TPE compositions of the present invention, including without limitation medical articles or devices, tubes, films, etc.

In a preferred embodiment of the present invention, the TPE composition has a melt flow rate (MFR) between 5 and 50, preferably between 10 and 40, more preferably between 15 and 35, wherein the MFR (g/10′) is measured at 230° C. and 2.16 kg.

In another preferred embodiment of the present invention, the TPE composition has a tensile strength (i.e., at break) measured at room temperature (i.e., 25° C.) higher than 9 MPa, preferably higher than 11 MPa, more preferably higher than 13 MPa.

In another preferred embodiment of the present invention, the TPE composition has a maximum elongation (i.e., elongation at break) measured at room temperature (i.e., 25° C.) higher than 400%, preferably higher than 600%, more preferably higher than 700%.

The styrenic block copolymer compositions comprising at least one high vinyl block copolymer of the present invention, wherein the high vinyl block copolymer is or is not hydrogenated, find application for high flow SEBS copolymers as disclosed in European patent EP 1,730,201 and U.S. Pat. No. 7,439,301, which are incorporated by reference. High vinyl SEBS are particularly useful for the manufacture of articles where it is required to avoid the usage of plasticizers and low molecular weight additives that could potentially migrate and affect use, haptics and/or health of users. Moreover, high vinyl content in SBS copolymer precursor allows: SEBS exhibiting high compatibility with polypropylene as disclosed in European patent EP 1,002,813, which is incorporated by reference, making them very useful for the manufacture of elastic films, fibers and non-wovens compounds and materials; coupled high vinyl SBS copolymers finds use as precursor for SEBS intended for soft elastomeric films; precursors for SEBS copolymers used in oil gel compositions for use in cable filling compounds as disclosed in European patent EP 0,822,227, which is incorporated by reference; precursors for SEBS intended for sealant formulations as disclosed in U.S. Pat. No. 5,777,043, which is incorporated by reference; precursors for SEBS that provide high clarity and improved mechanical properties when compounded with polyolefins as disclosed in U.S. Patent Application No. 2010/0331465 A1,which is incorporated by reference; for the formulation of polypropylene compositions with oxygen-absorbing capability as disclosed in U.S. Patent Application No. 2012/0252922 A1, which is incorporated by reference; for use in radiation curable hot melt adhesive compositions as disclosed in U.S. Pat. No. 6,486,229, which is incorporated by reference; and for use in hot melt pressure sensitive adhesives as disclosed in U.S. Patent Application No. 2015/0191637 A1, which is incorporated by reference.

Thermoplastic elastomer (TPE) compositions of high vinyl content SEBS with polypropylene exhibit higher tensile strength and elongation at break than prior art compositions. Styrenic block copolymer compositions comprising at least one high vinyl block copolymer of the present invention provide an improved balance of rheological (i.e., melt flow rate) and mechanical properties (i.e., tensile strength and elongation). Moreover, SEBS exhibiting high melt flow could be used in many applications, either as a neat polymer or in a compound, including injection molding to produce medical devices, over molding applications for personal care, soft touch materials, and automotive parts, blown film, dipped goods, and films and fibers.

The styrenic block copolymer compositions comprising at least one high vinyl block copolymer of the present invention are suitable for end-use applications such as: toughened plastic compositions, asphalt or bituminous compositions, solvent based adhesive compositions, hot melt adhesive compositions, sealant formulations, and others, as disclosed in European patent EP 2,668,214 B1 and U.S. Pat. No. 11,370,873 B2, and U.S. Patent Application No. 2022/0396654 A1, which are incorporated by reference. The styrenic block copolymer compositions comprising at least one high vinyl block copolymer of the present invention are also suitable for thermoplastic elastomer (TPE) compositions, compounding, microcellular foamed compositions, oil gel compositions, piezoresistive ink compositions, battery cell binder compositions, and others, as disclosed in European patents EP 2,489,688 B1, EP 3,325,519 B1, EP 3,397,702 B1, EP 3,853,274 B1 and EP 4,150,683 B1, and European patent application EP 4,183,809 A1 and U.S. Patent Application No. 2022/0396654 A1, which are incorporated by reference.

The styrenic block copolymer compositions comprising at least one high vinyl block copolymer of the present invention are suitable for piezoresistive ink compositions as disclosed in European patent EP 3,397,702 B1. A piezoresistive ink composition consists of a polymer-based ink that when printed to a geometry desired allows the development of piezoresistive sensors. The piezoresistive ink composition comprises conductive nanostructures, a thermoplastic elastomer polymer as polymer matrix and a dispersive agent, which can be applied on different substrates through different printing techniques such as drop casting, spray, screen or inkjet printing, and can be useful for electronics, biomedical or automotive. The polymer matrix provides clasticity and stretchability to the piezoresistive sensors, which is based on triblock copolymers such as styrene-butadiene-styrene (SBS) due to its low-temperature flexibility, chemical stability and electrical insulator properties. The styrene/butadiene (S/B) block copolymers influence their mechanical properties such as large elasticity and low mechanical hysteresis. Further, styrene-ethylene/butylene-styrene (SEBS) copolymers allow the development of biocompatible sensors and improved ozone resistance. Furthermore, the polymer matrices can be adapted to application by changing butadiene/styrene ratio to provide specific clasticity to the piczoresistive sensor. The styrenic block copolymer compositions comprising at least one high vinyl block copolymer of the present invention are suitable for piezoresistive ink compositions given that they provide an improved balance of rheological (i.e., melt flow rate) and mechanical properties (i.e., tensile strength and elongation).

The styrenic block copolymer compositions comprising at least one high vinyl block copolymer of the present invention are suitable for lithium-ion battery binder compositions as disclosed in European patent EP 4,150,683 B1. A lithium-ion battery binder composition consists of a linear styrene-ethylene/butylene-styrene (SEBS) copolymer having a high melt flow rate, a relatively low molecular weight and low styrene content. The linear SEBS binder in the active layer of an electrode provides batteries with better performance, particularly having an improved specific capacity. The linear SEBS binder shows high adhesion to the current collectors, excellent mechanical properties and good thermal stability. The styrenic block copolymer compositions comprising at least one high vinyl block copolymer of the present invention are suitable for lithium-ion battery binder compositions given that they provide an improved balance of rheological (i.e., melt flow rate) and mechanical properties (i.e., tensile strength and elongation).

The styrenic block copolymer compositions comprising at least one high vinyl block copolymer of the present invention are suitable for high temperature properties SEBS compositions as disclosed in European patent EP 2,489,688 B1. Hydrogenated styrene/butadiene rubber grades with an improved high-temperature performance, which despite having high molecular weight provide improved processability/mouldability and optimize the cross-linking scope in vulcanized formulations. SEBS polymer with significantly lower viscosity constitutes an improvement in compression resistance for non-vulcanized formulations as well as for vulcanized formulations. The method to determine recovery capacity of a material is the compression set method in accordance with standard ASTM D395 82 (method B: compression set under constant deflection). The compression set tests measure the ability of rubber compounds to maintain elastic properties after the prolonged action of compression stress. These tests are frequently performed at high temperatures. An improved elastomeric thermoplastic composition comprising SEBS polymers exhibits compression resistance at temperatures between 20° C. and 100° C. SEBS polymers may be linear or radial, with vinyl content of less than 60% and styrene content of between 30% and 41%, with molecular weight (Mpeak SEBS) of between 200,000 and 600,000 as determined by GPC and Brookfield viscosity at 5% by weight in cyclohexane of less than 300 cP. Examples of compressed molded articles: in the automobile sector are door handles, lateral protection systems, filters and oil hydraulic accessories, aeration tubes and hoses, window and door contours; in construction are window contours, insulation, gaskets; utensils for home use such as hermetic container lids; and manufacturing of medical utensils such as catheters, wire coatings, etc. The styrenic block copolymer compositions comprising at least one high vinyl block copolymer of the present invention are suitable for high temperature properties SEBS compositions given that they provide an improved balance of rheological (i.e., melt flow rate) and mechanical properties (i.e., tensile strength and elongation).

The styrenic block copolymer compositions comprising at least one high vinyl block copolymer of the present invention are suitable for thermoplastic elastomer (TPE) compositions as disclosed in European patent EP 3,325,519 B1. TPE compositions are typically made of a block copolymer, a thermoplastic resin and a plasticizer agent. In the medical and healthcare industry, articles made from TPE compositions, such as pharmaceutical seals and medical stoppers or penetrable septa, show important advantages over those made of compositions using “traditional” materials, such as natural rubber, butyl or halobutyl rubber or silicone based rubber. TPE requirements for medical applications are: reprocessability and reduction of cycle times as compared with vulcanized materials; elastic behaviour, which translates in increased resistance to fracture and rescalability; free of toxic solvents, which result from traditional vulcanization processes; non-allergenic as compared with natural rubber; low hardness; resistance to compression; chemical resistance; reduced permeability to oxygen; resistance to sterilization; high melt flow rate; rescalability; reduced oil bleeding; and fracture resistance after puncture. Hydrogenated styrenic block copolymers, in particular styrene-ethylene/butylene-styrene copolymers (SEBS copolymers), provide improved performance in thermoplastic elastomer compositions (TPE compositions), namely in terms of processability, rescalability, permeability, hardness, chemical resistance, resistance to sterilization, oil bleeding and puncture resistance, and articles made of said TPE compositions are particular suitable for medical applications. The hydrogenated styrenic block copolymers provide non-vulcanized or vulcanized TPE compositions with improved processability, rescalability, low permeability to oxygen, minimized oil bleeding, while maintaining adequate hardness, dimensional stability, chemical resistance and resistance to sterilization, and a good balance of key properties, e.g. melt flow rate and permeability to oxygen. TPE compositions comprising hydrogenated styrenic block copolymers are suitable for medical articles or devices such as: medical stoppers; pharmaceutical seals; vial seals; penetrable septa; bottle caps, seals and plugs; tubes; films; and closures. The styrenic block copolymer compositions comprising at least one high vinyl block copolymer of the present invention are suitable for thermoplastic elastomer (TPE) compositions for medical applications given that they provide an improved balance of rheological (i.e., melt flow rate) and mechanical properties (i.e., tensile strength and elongation).

The following examples have the purpose of showing the features of the present invention and are not intended to limit the scope thereof. Comparative examples using prior art technologies are included as reference. Characterization of copolymer microstructure was performed by 300 MHz 1H-NMR technique, and molecular weight characterization using GPC with 3-column set, coupled to differential refractive index detector. Peak molecular weights, coupling percentages, and polydispersity indexes Mw/Mn reported are referred to calibration curve based on polystyrene standards with narrow molecular weight distribution. Characterization of degree of hydrogenation (i.e., BdH in wt % relative to butadiene content) of the SEBS block copolymers was performed by 500 MHz 1H-NMR technique.

Regarding to the SEBS characterization, the melt flow index (MFI), also known as melt flow rate, was measured through the ASTM D-1238-20 method at 230° C. and 2.16 kg and the Brookfield viscosity was measured following the ASTM D2196-20 methodology.

Regarding to the TPE characterization, the mechanical properties were measured through the ASTM D412 method at room temperature (i.e., 25° C.).

Example 1: Uncoupled SBS block copolymer using preferred polar modifier system of invention: High polar modifier system concentration, high molecular weight copolymer synthesis at low temperature range.

Cyclohexane (5383 g) was charged in to a 7.6-liter stainless steel reactor under inert nitrogen atmosphere. Solvent temperature was stabilized in the reactor at 18.1° C. (Tst1) by means of water circulation through reactor internal coil. Thereafter BDMAEE, DTHFP, n-butyllithium initiator (nBuLi) initiator and SMT were added in the listed order. DTHFP, BDMAEE and SMT molar ratios relative to active lithium content were 4.17, 0.52 and 0.10, respectively. Styrene (84.5 g) was feed to the reactor at a rate adequate to complete its charge in 0.5 minutes. Circulation of water at controlled temperature was continued along first styrene block polymerization. Reactor temperature reached a peak temperature of 19.7° C. in 3 minutes, and a wait time of 2 minutes was practiced, therefore first block homopolymerization time was 5 min (tSt). Then reactor cooling was terminated and immediately after butadiene (344.7 g) was fed in a period of about 2 minutes. Temperature right at the start of butadiene feed was 19.2° C. (Ti-Bd). Butadiene polymerization reached a peak temperature of 43° C. (Tp-Bd), 9 minutes after beginning butadiene loading (tp-Bd). In every case butadiene polymerization occurred without circulation of water thru the jacket. There was a wait time of 3 minutes (twBd) before the second styrene (84.5 g) was fed to reactor. It was detected a peak temperature past 3 minutes of second styrene charge. Past 5 minutes an alcohol was fed to terminate polymer anions. Cyclohexane to overall monomer mass ratio in this procedure was 8. A block copolymer was obtained of following characteristics: Peak molecular weight Mp=277.8 kg/mol, polydispersity index Mw/Mn=1.06, total styrene repeat unit content of 31.9 wt %, random styrene repeat unit content of 3.9 wt %, total vinyl content of 90.9 wt % on a butadiene block basis (1,2-vinyl+VCP), and of 89.4 mol % on repeat unit basis, VCP content of 3.1 wt %. Molecular weight distribution of this SBS copolymer exhibited a unimodal narrow peak shape.

Example 2: Uncoupled SBS block copolymerization using preferred polar modifier system of invention: Medium polar modifier concentration range, medium molecular weight copolymer synthesis at low temperature range.

The block copolymer was prepared in a 5.3-liter lab scale batch thru the following steps: (1) charge of cyclohexane solvent to a reactor; (2) stabilization of solvent to a temperature Ti; (3) charge of polar modifiers BDMAEE and DTHFP; (4) charge of n-butyllithium; (5) charge of SMT; (6) charge of styrene monomer; (7) immediate interruption of reactor temperature control to perform polymerization in absence of external cooling or external heating, apart from natural heat loss to the environment (8) homopolymerization of first styrene block for a period of time tSt1, where heat of polymerization gradually raised reactor temperature without detection of temperature drop that evidenced a peak temperature during such period; (9) registration of reactor temperature TiBd and immediate charge of butadiene monomer; (10) butadiene block copolymerization, where heat of reaction raised reactor temperature to a peak temperature TpBd which was registered, as well as time tpBd elapsed from beginning of butadiene charge to the moment TpBd occurred; (11) wait time twBd; (12) charge of second styrene load; (13) polymerization of second polystyrene block until full consumption of styrene monomer; (14) charge of excess equivalents of an alcohol to assure termination of all polymer anions. In this formulation 2938 g of cyclohexane were used, 60.9 g of styrene were used to build polystyrene first block, 246.1 g of butadiene were used to build high vinyl polybutadiene middle block, and 60.9 g of styrene were used to build polystyrene end block. Thus, overall solvent to monomer ratio (S/M) was 8.0. Feed time of each styrene load was 0.5 minutes long. Feed time for butadiene load was 2 minutes long. Active n-butyllithium charge was 4.2 mmol. DTHFP, BDMAEE and SMT molar ratios relative to active lithium content were 2.13, 0.27 and 0.05,respectively (See Table 1). First styrene charge was homopolymerized for 3 minutes, from a starting temperature of 10.8° C. to reach 15.0° C. High vinyl polybutadiene block polymerization evolved from a temperature of 15 to a peak temperature of 46.70° C. in 11 minutes (See Table 2). A block copolymer was obtained of following characteristics: total styrene repeat unit content of 34.6 wt %, random styrene repeat unit content of 3.3 wt %, total vinyl content of 87.6 wt % on a butadiene block basis (1,2-vinyl+VCP), total vinyl content of 85.8 mol % on repeat unit basis, VCP content of 3.7 wt % on a butadiene block basis. (See Table 3) Molecular weight distribution of this SBS copolymer exhibited a unimodal narrow peak shape, with molecular weight Mp=142.3 kg/mol and polydispersity index Mw/Mn=1.03; (See Table 4).

Comparative example C1: Uncoupled SBS block copolymerization using polar modifier systems of closest prior art, BDMAEE/SMT at low temperature range.

A block copolymer was prepared in the same 5.3-liter reactor of Example 2. Same procedure of example 2, as well as same amounts of cyclohexane, butadiene and styrene charges were employed. Prior art polar modifier system BDMAEE/SMT was evaluated. As in example 2, BDMAEE was fed before n-butyllithium initiator and SMT was fed after n-butyllithium. Active n-butyllithium charge was 4.4 mmol. BDMAEE and SMT molar ratios relative to active lithium content were 0.59 and 0.05, respectively (See Table 1). First styrene charge homo-polymerization took 11 minutes to reach 15.0° C. from a starting temperature of 10.7° C. High vinyl polybutadiene block polymerization evolved from a temperature of 15° C. to a peak temperature of 46.0° C. in 17 minutes (See Table 2). A block copolymer was obtained of following characteristics: total styrene repeat unit content of 33.7 wt %, random styrene repeat unit content of 4.3 wt %, total vinyl content of 90.6 wt % on a butadiene block basis (1,2-vinyl+VCP), total vinyl content of 88.7 mol % on repeat unit basis, VCP content of 3.8 wt % on a butadiene block basis. (See Table 3) Molecular weight distribution of this SBS copolymer exhibited a bimodal shape, with a main peak at a molecular weight Mp=123.7 kg/mol, and secondary peak at Mp2=178.9 kg/mol, with a polydispersity index Mw/Mn=1.08; (See Table 4 and FIG. 2). Total vinyl content of the SBS obtained in this comparative example almost reached the 90.9wt % level obtained in invention Example 1. Random styrene content ratio to total styrene content was also very alike, to what was obtained in example 1: about 12.8% of the styrene was randomized with butadiene and 87.2% became part of polystyrene blocks in comparative example using BDMAEE/SMT system, whereas 12.2% random and 87.8% in form of block in invention Example 1. Nevertheless, this comes at expense of un-acceptable attributes in the comparative product: bimodal and wide molecular weight distribution in comparative example 1 is a sign of premature termination of the polymer anions; thus, copolymer produced very likely consist of a blend of low molecular weight di-block copolymer, SB, that stop propagating prematurely and high molecular weight SBS with un-symmetrical size of polystyrene blocks. Both factors compromise mechanical properties of the copolymer. The polymerization also becomes disadvantageously slow with this comparative polar modifier system: it took 15 minutes to polymerize first styrene block in the comparative example 1, while 3 minutes in invention Example 2; butadiene polymerization is also slower with BDMAEE/SMT system, it took 17 minutes to reach peak temperature in the comparative example, when for the same temperature rise 11 minutes were required with invention system in example 2.

Comparative example C2: Uncoupled SBS block copolymerization using polar modifier systems of closest prior art, BDMAEE/SMT at low temperature range. As in example 2, BDMAEE was fed before n-butyllithium initiator and SMT was fed after n-butyllithium. Active n-butyllithium charge was 4.4 mmol. BDMAEE and SMT molar ratios relative to active lithium content were 0.36 and 0.05, respectively (See Table 1). After 15 minutes of first styrene block homo-polymerization reactor temperature barely reached 13.6° C. from a starting temperature of 10.5° C. High vinyl polybutadiene block polymerization evolved from a temperature of 13.6° C. to a peak temperature of 41.2 ° C in 42 minutes (See Table 2). A block copolymer was obtained of following characteristics: total styrene repeat unit content of 34.9 wt %, random styrene repeat unit content of 10.6 wt %, total vinyl content of 87.0 wt % on a butadiene block basis (1,2-vinyl+VCP), total vinyl content of 85.0 mol % on repeat unit basis, VCP content of 4.2 wt % on a butadiene basis. (See Table 3) Molecular weight distribution of this SBS copolymer exhibited a unimodal peak slightly skewed towards low molecular weight range, with a main peak at a molecular weight Mp=154.5 kg/mol and a polydispersity index Mw/Mn=1.05; (See Table 4 and FIG. 2). The main change in Comparative Example C2 vs. Comparative Example C1 was a reduction of BDMAEE molar ratio to active nBuLi from 0.59 to 0.36, while SMT/nBuLi molar ratio remained at 0.05. This reduced the vinyl content from 90.6 in Comparative Example C1 to 87.0 in Comparative Example C2. The effect in reduction of vinyl content was very alike to the effect of reducing by half the dosage of ternary polar modifier system of invention from a DTHFP/BDMAEE/SMT/nBuLi molar ratio of 4.17/0.52/0.1/1 in invention Example 1 to 2.13/0.27/0.05/1 in invention Example 2, with an associated drop of 90.9 wt % total vinyl to 87.6 wt %, respectively. Molecular weight distribution improved in Comparative Example C2 vs. Comparative Example C1, as bimodality was avoided, but still some skewedness in the distribution evidenced some premature polymer anion termination. As can be seen in FIG. 2, molecular weight distribution of SBS obtained with polar modifier DTHFP/BDMAEE/SMT in invention Example 1 was more narrow and symmetrical than that of copolymer produced in Comparative Example C2. The most deleterious effect of the slight reduction of BDMAEE content in Comparative Example C2 recipe was in polymerization speed and in randomized styrene content: in Comparative Example C2 time allowed for first styrene block homo-polymerization was increased by a factor of 5 in comparison of time needed in invention Example 2, and even this was not enough to reach the 15° C. target expected. Butadiene polymerization in Comparative Example C2 was also very slow, it was required 42 minutes to reach butadiene peak temperature, whereas in invention Example 2 only 11 minutes were needed. Although a longer wait time after butadiene peak temperature was allowed in Comparative Example C2 before feeding second styrene load than in invention Example 2, being 5 and 2 minutes, respectively, randomized styrene was very high: 30.4% of the styrene was randomized only 69.6% became part of the polystyrene blocks, whereas in invention Example 2 only 9.5% of the styrene became randomized (calculated as random styrene content on a SBS basis over total styrene contents on a SBS basis).

A block copolymer was prepared in the same 5.3-liter reactor of Example 2. Same procedure of example 2, as well as same amounts of cyclohexane, butadiene and styrene charges were employed. Prior art polar modifier system BDMAEE/SMT was evaluated at lower dosage than in Comparative example C1.

TABLE 1
Initiator and polar modifier system loadings in examples 1 and 2, according
with the invention, and comparative examples C1 thru C6, using previous art.

| | n-BuLi, | DTHFP, | BDMAEE, | SMT, | TMEDA, | DMTHFMA, | ETE, |
|---|---|---|---|---|---|---|---|
| | mmol | mol/ | mol/ | mol/ | mol/ | mol/ | mol/ |
| Example | active | Li mol | Li mol | Li mol | Li mol | Li mol | Li mol |
| 1 | 3.1 | 4.17 | 0.52 | 0.10 | 0 | 0 | 0 |
| 2 | 4.2 | 2.13 | 0.27 | 0.05 | 0 | 0 | 0 |
| C1 | 4.4 | 0 | 0.59 | 0.05 | 0 | 0 | 0 |
| C2 | 4.4 | 0 | 0.36 | 0.05 | 0 | 0 | 0 |
| C3 | 4.3 | 3.11 | 0 | 0 | 0 | 0 | 0 |
| C4 | 4.9 | 0 | 0 | 0 | 0 | 0 | 9.3 |
| C5 | 4.0 | 0 | 0 | 0.12 | 4.5 | 0 | 0 |
| C6 | 4.6 | 0 | 0 | 0.10 | 0 | 3.9 | 0 |

TABLE 2
Polymerization process parameters in examples 1
and 2, according with the invention, and comparative
examples C1 thru C6, using previous art.

| | Ti, | tSt, | Ti-Bd, | Tp-Bd, | tpBd, | twBd, |
|---|---|---|---|---|---|---|
| Example | ° C. | min | ° C. | ° C. | min | min |
| 1 | 18.1 | 5 | 19.2 | 43 | 9 | 3 |
| 2 | 10.8 | 3 | 15.0 | 46.7 | 11 | 2 |
| C1 | 10.7 | 11 | 15.0 | 46.0 | 17 | 5 |
| C2 | 10.5 | 15 | 13.6 | 41.2 | 42 | 5 |
| C3 | 10.8 | 5 | 14.9 | 44.6 | 21 | 11 |
| C4 | 10.3 | 12 | 14.3 | 44.0 | 18 | 7 |
| C5 | 10.7 | 4 | 15.0 | 47.6 | 14 | 11 |
| C6 | 10.9 | 3 | 15.1 | 48.7 | 9 | 5 |

TABLE 3
NMR characterization of SBS copolymer produced in in examples 1 and 2, according
with the invention, and comparative examples C1 thru C6, using previous art.

| | Total | Block | Random | 1,2-vinyl, | VCP, | Total vinyl, | Total vinyl, |
|---|---|---|---|---|---|---|---|
| | Styrene, | styrene, | styrene, | wt %, | wt %, | 1,2 + VCP, | 1,2 + VCP, |
| Example | wt % | wt % | wt % | Bd basis | Bd basis | wt %, Bd basis | mol %, Bd basis |
| 1 | 31.9 | 28.0 | 3.9 | 87.8 | 3.1 | 90.9 | 89.4 |
| 2 | 34.6 | 31.3 | 3.3 | 83.9 | 3.7 | 87.6 | 85.8 |
| C1 | 33.7 | 29.4 | 4.3 | 86.8 | 3.8 | 90.6 | 88.7 |
| C2 | 34.9 | 24.3 | 10.6 | 82.9 | 4.2 | 87.0 | 85.0 |
| C3 | 34.0 | 30.2 | 3.8 | 78.2 | 3.0 | 81.2 | 79.7 |
| C4 | 32.9 | 31.4 | 1.5 | 80.2 | 2.4 | 82.6 | 81.4 |
| C5 | 34.8 | 31.7 | 3.1 | 79.1 | 4.2 | 83.3 | 81.2 |
| C6 | 34.2 | 31.2 | 3.0 | 71.5 | 5.1 | 76.6 | 74.1 |

TABLE 4
GPC characterization of SBS copolymer produced in example 1,
according with the invention, and comparative examples C1 thru C6,
using previous art.

| | Mp, | | |
|---|---|---|---|
| Example | kg/mol | Mw/Mn | MWD Shape |
| 1 | 277.4 | 1.06 | Unimodal narrow peak |
| 2 | 142.3 | 1.03 | Unimodal narrow peak |
| C1 | 123.7 | 1.08 | Bimodal peak, Mp2 = 179 kg/mol |
| C2 | 154.5 | 1.05 | Unimodal peak, slightly skewed towards |
| | | | low MW |
| C3 | 138.5 | 1.03 | Unimodal narrow peak |
| C4 | 123.7 | 1.02 | Unimodal narrow peak |
| C5 | 150.6 | 1.04 | Unimodal narrow peak |
| C6 | 130.3 | 1.04 | Unimodal narrow peak |

FIG. 2. Molecular weight distribution of copolymer produced in example 2, according with invention, and comparative examples C1 and C2, using prior art.

When comparing speed of styrene homopolymerization stage of high vinyl copolymer obtained with polar modifier system of the invention DTHFP/BDMAEE/SMT, used in example 2, against prior art modifier system of prior art based on BDMAEE/SMT, used in comparative examples C1, it can be noticed that temperature rise to 15°20 C. of first styrene block homopolymerization occurred in almost four times shorter period with invention than with prior art. When comparing time to reach butadiene block stage peak temperature, tpBd, polar modifier of invention tested in example 2 enabled also faster butadiene polymerization than prior art used in example C1. In addition, a shorter wait time twBd was needed with invention polar modifier in example 2 than with prior art practiced in example C1 to obtain lower random styrene content in SBS copolymer. Moreover, in example 1 BDMAEE/Li ratio was half of that used in comparative example C1.

When comparing molecular weight distribution obtained with polar modifier of invention DTHFP/BDMAEE/SMT, used in example 2, against prior art based on polar modifier system BDMAEE/SMT, of comparative example C1, it can be noticed that an unimodal narrow peak was obtained with invention, whereas a wide bimodal peak was obtained with prior art (see FIG. 2). Unimodal narrowly distributed molecular weight distribution obtained with polar modifier of invention in example 2 confirms that most of SBS copolymer molecules so produced grew to the same average molecular weight, and very likely as symmetrical S-b-B-b-S copolymer. Bimodal and wide molecular weight distribution obtained with prior art is explained by premature termination of polymer anions along polymerization: copolymer chains that fall in the lower molecular weight range of the bimodal distribution are prone to lack incorporation of polystyrene end block, while those that fall in the high molecular weight range of the distribution are prone to have a longer polystyrene end block than their firstly incorporated polystyrene block. Then, product of comparative example C1 is expected to be a blend with more than 50wt % of S-b-B di-block copolymer and less than 50 wt % of un-symmetrical S-b-B-b-S tri-block copolymer.

In comparative example C2, that evaluated prior art BDMAEE/SMT polar modifier system with a BDMAEE/Li ratio lower than in comparative example C1, but still higher amount of BDMAEE than in invention example 2, polymerization proceeded at still lower speed and incorporated much more random styrene repeat units in the copolymer. Its molecular weight distribution improved towards a unimodal peak, but still appeared slightly wider than that of invention example 2, and skewed towards low molecular weight range, evidencing some premature termination of polymer anions.

Invention example 2, based on DTHFP/BDAMEE/SMT polar modifier system produced SBS block copolymer with very high level of 1,2-vinyl butadiene repeat units, slightly higher than what obtained in comparative example C2 based on polar modifier system of prior art BDMAEE/SMT. Advantageously, VCP level was slightly lower in invention example 2 than in comparative examples C1 and C2.

When comparing invention example 2, based on DTHFP/BDMAEE/SMT polar modifier system against other prior art polar modifier systems, as DTHFP in comparative example C3, ETE in comparative example C4, TMEDA/SMT in comparative example C5 and DMTHFMA/SMT in comparative example C6, it can be noticed that invention polar modifier system conducts to faster polymerization than most of prior art polar modifier systems, and just slightly slower than with DMTHFMA/SMT system. Molecular weight distribution unimodality and narrowness of copolymer obtained by invention was competitive with these other polar modifier systems, as reveal by low values of polydispersity index Mw/Mn. Nevertheless, none of these other prior art polar modifier systems was capable of surpassing 1,2-vinyl incorporation level of invention. Moreover, TMEDA/SMT tried in comparative example C5 and DMTHFMA/SMT produced higher levels of VCP than invention example 1.

Examples 3 thru 8: Uncoupled SBS block copolymerization using preferred polar modifier system invention, at medium temperature range. An S-b-B-b-S type block copolymer was prepared in a lab scale batch reactor thru the following steps: (1) charge of cyclohexane solvent to a reactor; (2) stabilization of solvent to a temperature Ti; (3) charge of polar modifiers BDMAEE and DTHFP; (4) charge of n-butyllithium; (5) charge of SMT; (6) charge of styrene monomer; (7) immediate interruption of reactor temperature control to perform polymerization in absence of external cooling or heating, apart from natural heat loss to the surroundings (8) homopolymerization of first styrene block, where heat of polymerization gradually raised reactor temperature up to a peak temperature TpSt at a time tpSt elapsed from beginning of styrene charge and such peak temperature; (9) a wait time of 10 minutes past TpSt, where a slight temperature drop occurred; (10) registration of reactor temperature TiBd and immediate charge of butadiene monomer; (11) butadiene block copolymerization, where heat of reaction raised reactor temperature to a peak temperature TpBd which was registered, as well as time tpBd elapsed from beginning of butadiene charge to the moment TpBd occurred; (12) wait time of 1 minute past TpBd, where a slight temperature drop occurred; (13) charge of second styrene load; (14) polymerization of second polystyrene block until full consumption of styrene monomer; (15) charge of excess equivalents of an alcohol to assure termination of all polymer anions. In this formulation 2795 g of cyclohexane were used, 63.6 g of styrene were used to build polystyrene first block, 246.1 g of butadiene were used to build high vinyl polybutadiene middle block, and 63.6 g of styrene were used to build polystyrene end block. Thus, overall solvent to monomer ratio was 7.5. Feed time of each styrene load was 0.5 minutes long. Feed time for butadiene load was 2 minutes long. Active initiator content and polar modifier molar ratios to initiator are shown in Table 5. High vinyl polybutadiene block was polymerized in a temperature range from 22.8 to 56.8° C. Process parameters Ti, TpSt, tpSt, TiBd, TpBd and tpBd are listed in Table 6. SBS copolymer characterization of product from this example is shown in Table 7 and Table 8.

Examples 9 thru 11: Uncoupled SBS block copolymerization using alternative polar modifier system invention, at medium temperature range. The same operations listed in examples 3 thru 7 were employed, but DTHFP was replaced by either ETE, TMEDA or DMTHFMA. Active n-butyllithium and polar modifier system dosages for these examples are reported in Table 5. High vinyl polybutadiene block was polymerized in a temperature range from 23 to 59.8° C. Process parameters Ti, TpSt, tpSt, TiBd, TpBd and tpBd are listed in Table 6 for each example. SBS copolymer characterization of products from these examples is shown in Table 7 and Table 8.

Comparative examples C7 and C8. Uncoupled SBS block copolymerization using polar modifier system of closest prior art, at medium temperature range. The same procedure described in examples 3 thru 7 was employed, but DTHFP was avoided. Active n-butyllithium and polar modifier system dosages for these comparative examples are reported in Table 5. High vinyl polybutadiene block was polymerized in a temperature range from 23.5 to 57oC. Process parameters Ti, TpSt, tpSt, TiBd, TpBd and tpBd are listed in Table 6 for each comparative example. SBS copolymer characterization of products from these comparative examples is shown in Table 7 and Table 8.

TABLE 5
Initiator and polar modifier system loadings in example 3 thru 11, according
with the invention, and comparative examples C7 and C8, using previous art.

| | n-BuLi, | DTHFP, | ETE, | TMEDA, | DMTHFMA, | BDMAEE, | SMT, |
|---|---|---|---|---|---|---|---|
| | mmol | mol/ | mol/ | mol/ | mol/ | mol/ | mol/ |
| Example | active | Li mol | Li mol | Li mol | Li mol | Li mol | Li mol |
| 3 | 4.7 | 2.60 | 0 | 0 | 0 | 0.74 | 0.06 |
| 4 | 3.8 | 3.02 | 0 | 0 | 0 | 0.80 | 0.04 |
| 5 | 4.4 | 0.36 | 0 | 0 | 0 | 0.61 | 0.05 |
| 6 | 4.0 | 2.17 | 0 | 0 | 0 | 0.58 | 0.05 |
| 7 | 4.0 | 2.15 | 0 | 0 | 0 | 0.27 | 0.05 |
| 8 | 5.9 | 1.95 | 0 | 0 | 0 | 0.52 | 0.02 |
| 9 | 4.8 | 0 | 2.52 | 0 | 0 | 0.72 | 0.05 |
| 10 | 4.0 | 0 | 0 | 3.03 | 0 | 0.87 | 0.07 |
| 11 | 5.0 | 0 | 0 | 0 | 2.41 | 0.69 | 0.05 |
| C7 | 4.7 | 0 | 0 | 0 | 0 | 0.92 | 0.06 |
| C8 | 4.7 | 0 | 0 | 0 | 0 | 0.74 | 0.06 |

TABLE 6
Polymerization process parameters in example 3
thru 11, according with the invention, and comparative
examples C7 and C8, using previous art.

| | Ti, | TpSt, | tpSt, | Ti-Bd, | Tp-Bd, | tpBd, |
|---|---|---|---|---|---|---|
| Example | ° C. | ° C. | min | ° C. | ° C. | min |
| 3 | 18.4 | 23.4 | 7 | 23.0 | 56.8 | 9 |
| 4 | 18.1 | 23.0 | 12 | 22.8 | 55.4 | 11 |
| 5 | 21.5 | 26.3 | 13 | 26.1 | 56.4 | 17 |
| 6 | 20.2 | 25.2 | 9 | 25.0 | 58.7 | 10 |
| 7 | 18.2 | 23.1 | 7 | 22.9 | 55.6 | 12 |
| 8 | 18.1 | 23.0 | 9 | 22.9 | 55.1 | 12 |
| 9 | 18.2 | 23.6 | 4 | 23.2 | 56.5 | 10 |
| 10 | 18.2 | 23.1 | 15 | 23.0 | 58.4 | 7 |
| 11 | 18.8 | 24.3 | 6 | 23.5 | 59.8 | 7 |
| C7 | 18.3 | 23.5 | 15 | 23.5 | 57.0 | 10 |
| C8 | 19.4 | 23.5 | 30 | 23.5 | 55.8 | 13 |

TABLE 7
NMR characterization of SBS copolymer produced in in example 3 thru 11, according
with the invention, and comparative examples C7 and C8, using previous art.

| | Total | Block | Random | 1,2-vinyl, | VCP, | Total vinyl, | Total vinyl, |
|---|---|---|---|---|---|---|---|
| | Styrene, | styrene, | styrene, | wt %, | wt %, | 1,2 + VCP, | 1,2 + VCP, |
| Example | wt % | wt % | wt % | Bd basis | Bd basis | wt %, Bd basis | mol %, Bd basis |
| 3 | 34.3 | 33.3 | 1.0 | 84.1 | 4.7 | 88.8 | 86.5 |
| 4 | 34.9 | 32.8 | 2.1 | 83.3 | 4.2 | 87.5 | 85.4 |
| 5 | 34.3 | 32.7 | 1.6 | 83.5 | 3.7 | 87.2 | 85.3 |
| 6 | 34.1 | 33.1 | 1.0 | 82.7 | 4.6 | 87.3 | 85.0 |
| 7 | 34.2 | 32.5 | 1.7 | 81.9 | 3.9 | 85.7 | 83.9 |
| 8 | 34.3 | 33.2 | 1.1 | 80.9 | 4.2 | 85.1 | 83.0 |
| 9 | 34.6 | 33.6 | 1.0 | 83.4 | 4.1 | 87.5 | 85.5 |
| 10 | 34.9 | 32.5 | 2.3 | 83.3 | 6.8 | 90.1 | 86.7 |
| 11 | 33.0 | 32.5 | 0.5 | 81.9 | 4.6 | 86.4 | 84.2 |
| C7 | 34.1 | 33.1 | 1.0 | 85.5 | 5.0 | 90.5 | 88.0 |
| C8 | 34.3 | 32.6 | 1.7 | 86.2 | 4.1 | 90.4 | 88.3 |

TABLE 8
GPC characterization of SBS copolymer produced in example 3 thru 11,
according with the invention, and comparative examples C7 and C8,
using previous art.

| | Mp, | | |
|---|---|---|---|
| Example | kg/mol | Mw/Mn | MWD Shape |
| 3 | 129.8 | 1.04 | Unimodal narrow peak |
| 4 | 158.0 | 1.04 | Unimodal narrow peak |
| 5 | 137.6 | 1.06 | Unimodal narrow peak |
| 6 | 151.9 | 1.05 | Unimodal narrow peak |
| 7 | 150.1 | 1.05 | Unimodal narrow peak |
| 8 | 102.2 | 1.03 | Unimodal narrow peak |
| 9 | 125.8 | 1.07 | Unimodal narrow peak |
| 10 | 151.3 | 1.05 | Unimodal narrow peak |
| 11 | 121.5 | 1.04 | Unimodal narrow peak |
| C7 | 129.2 | 1.10 | Bimodal peak, Mp2 = 183.8 kg/mol |
| C8 | 175.7 | 1.08 | Bimodal peak, Mp2 = 132.6 kg/mol |

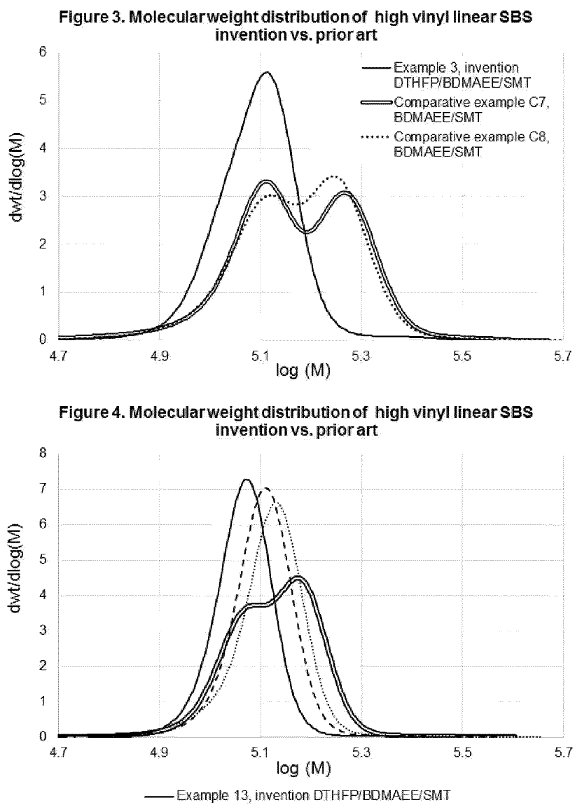

FIG. 3. Molecular weight distribution of copolymer produced in example 3, according with invention, and comparative examples C7 and C8, using prior art.

In invention examples 3 thru 8, based on polar modifier system DTHFP/BDMAEE/SMT, polar modifier ratios of DTHFP, BDMAEE and SMT relative to active lithium were swept in a wide composition range.

When comparing polymerization speed of invention examples 3 thru 8 based on DTHFP/BDMAEE/SMT against comparative examples C7 and C8 that used prior art BDMAEE/SMT polar modifier systems, most of compositions tried with invention polar modifier system obtained shorter polymerization times to reach first styrene block peak temperature and shorter times to reach butadiene polymerization peak temperature.

Advantageously, molecular weight distributions of invention examples 3 thru 8, based on DTHFP/BDMAEE/SMT polar modifier system, in every case exhibited a narrow unimodal peak shape with low polydispersity index Mw/Mn, whereas comparative compositions C7 and C8, based on prior art BDMAEE/SMT polar modifier system, produced wide bimodal molecular weight distributions with high polydispersity index Mw/Mn. FIG. 3, shows a relevant comparison of this behavior: invention example 3 and comparative example C8 have same active lithium, BDMAEE and SMT contents; incorporation of DTHFP in invention example 3 corrects wide bimodal molecular weight distribution of comparative examples C8. Higher dosage of BDMAEE in comparative example C7 slightly worsen molecular weight distribution widening, as revealed by FIG. 3 and polydispersity index Mw/Mn. Thus, prior art is adversely prone to produce higher contents of undesired di-block S-b-B copolymer and un-symmetrically S-b-B-b-S triblock copolymer than invention compositions.

Invention examples 9 thru 11 show options of appropriate polar modifiers that can replace DTHFP component of DTHFP/BDMAEE/SMT polar modifier system. Namely, systems ETE/BDMAEE/SMT, TMEDA/BDMAEE/SMT and DMTHFMA/BDMAEE/SMT perform as well as DTHFP/BDMAEE/SMT, rendering high speed polymerization of very high vinyl content block copolymers, with unimodal narrow molecular weight distribution. DTHFP/BDMAEE/SMT polar modifier system is a preferred option, as ETE/BDMAEE/SMT conducts to slightly higher polydispersity index Mw/Mn, TMEDA/BDMAEE/SMT lags in styrene homopolymerization step and produces higher VCP contents, while DMTHFMA/BDMAEE/SMT produces slightly lower 1,2-vinyl content. Nevertheless, this alternative invention systems still surpass performance of prior art systems described.

Although block copolymerization was carried out at higher temperature in invention examples 3 thru 11 than in comparative examples C2 thru C6, higher incorporation level of 1,2-vinyl content was obtained with the invention than with prior art also capable of producing narrowly molecular weight distributed SBS copolymer.

Example 12. Uncoupled SBS block copolymerization using preferred polar modifier system invention, at high temperature range. An S-b-B-b-S type block copolymer was prepared in a lab scale stirred batch reactor, with relatively low thermal insulation level, using the following procedure: Cyclohexane (2720 g) was charged in to a stirred reactor under nitrogen atmosphere, and its temperature was stabilized at 43.3° C. (Ti). Thereafter BDMAEE, DTHFP, n-butyllithium initiator and SMT were added to the reactor in the listed order. Active initiator content and polar modifier molar ratios to initiator are shown in Table 9. Then, a first part of styrene monomer (56.4 g) was charged to the reactor. Styrene feed operation was completed in 0.5 minutes. Reactor temperature control was discontinued thereafter, thus polymerization was carried out in the absence of external cooling, nor external heating, apart from heat dissipation to the environment. A peak temperature of 46.2° C. (TpSt1) was detected passed 2 minutes of styrene load (tpSt1). Then, a wait time of 3 minutes was practiced. By then, reactor temperature dropped to 44.2° C. (TiBd) and butadiene (227.5 g) feed operation began. Butadiene charge was completed in 2 minutes. Butadiene heat of polymerization raised reactant mass to a peak temperature of 61.1° C. (TpBd) in a period of 5 minutes (tpBd), counted from start of butadiene feed operation. Then, a wait time of 2 minutes (twBd) was taken between butadiene polymerization peak temperature and the beginning of second styrene load. Second styrene load to reactor (56.4 g) took 30 seconds to get completed. Second styrene load was polymerized for long enough time to be fully consumed, and then an alcohol was feed to reactor to terminate anionic polymer anions. Cyclohexane solvent to overall monomer feed ratio (S/M) in this example was 8. Process parameters Ti, TpSt1, tpSt1, TiBd, TpBd, tpBd and twBd are listed in Table 10. SBS copolymer characterization of product from this exmple is shown in Table 11 and Table 12.

Comparative example C9. Uncoupled SBS block copolymerization using polar modifier system of prior art, at high temperature range. An S-b-B-b-S type block copolymer was prepared in a lab scale stirred batch reactor, with relatively low thermal insulation level, using the following procedure: Cyclohexane (2862 g) and styrene monomer (63.0 g) were charged in to a stirred reactor under nitrogen atmosphere, and their temperature was stabilized at a temperature of 39.9° C. (Ti). Thereafter TMEDA, SMT and n-butyllithium initiator were added to the reactor in the listed order, and reactor temperature control was shut off. Active initiator content and polar modifier molar ratios to initiator are shown in Table 9. A peak temperature of 44.5° C. (TpSt1) was detected passed 5 minutes of initiator load (tpSt1). Then reactor was cooled down for 15 minutes to reach a temperature of 28° C. (TiBd). From this point on polymerization continued in absence of intended heating or cooling, apart from heat dissipation to the surroundings. Then butadiene (255.4 g) feed operation began. Butadiene charge was completed in 5 minutes. Butadiene heat of polymerization raised reactant mass to a peak temperature of 62.7° C. (TpBd) in a period of 10 minutes (tpBd), counted from start of butadiene feed operation. Then, a wait time of 5 minutes (twBd) was taken between butadiene polymerization peak temperature and the beginning of second styrene load. Second styrene load to reactor (63.0 g) was let polymerize for long enough time to be fully consumed. Then an alcohol was feed to reactor to terminate anionic polymer anions. Cyclohexane solvent to overall monomer feed ratio (S/M) in this example was 7.5. Process parameters Ti, TpSt1, tpSt1, TiBd, TpBd, tpBd and twbd are listed in Table 10. SBS copolymer characterization of product from this example is shown in Table 11 and Table 12.

TABLE 9
Initiator and polar modifier system loadings, as well as overall
solvent to monomer (S/M) ratio in example 12, according with the
invention, and in comparative example C9, using previous art.

| | n-BuLi, | DTHFP, | BDMAEE, | TMEDA, | SMT, | |
|---|---|---|---|---|---|---|
| Exam- | mmol | mol/ | mol/ | mol/ | mol/ | |
| ple | active | Li mol | Li mol | Li mol | Li mol | S/M |
| 12 | 5.1 | 1.7 | 0.21 | 0 | 0.04 | 8 |
| C9 | 4.8 | 0 | 0 | 3.8 | 0.08 | 7.5 |

TABLE 10
Polymerization process parameters in example 12, according with
the invention, and in comparative example C9, using previous art.

| | Ti, | TpSt1, | tpSt1, | Ti-Bd, | Tp-Bd, | tpBd, | twBd, |
|---|---|---|---|---|---|---|---|
| Example | ° C. | ° C. | min | ° C. | ° C. | min | min |
| 12 | 43.3 | 46.2 | 2.0 | 44.2 | 61.1 | 5 | 2 |
| C9 | 39.9 | 44.5 | 4.8 | 28 | 62.7 | 10 | 5 |

TABLE 11
NMR characterization of SBS copolymer produced in example 12, according
with the invention, and comparative examples C9, using previous art.

| | Total | Block | Random | 1,2-vinyl, | VCP, | Total vinyl, | Total vinyl, |
|---|---|---|---|---|---|---|---|
| | Styrene, | styrene, | styrene, | wt %, | wt %, | 1,2 + VCP, | 1,2 + VCP, |
| Example | wt % | wt % | wt % | Bd basis | Bd basis | wt %, Bd basis | mol %, Bd basis |
| 12 | 33.5 | 31.1 | 2.4 | 77.9 | 4.0 | 81.9 | 79.9 |
| C9 | 33.0 | 31.8 | 1.2 | 73.1 | 7.8 | 80.9 | 77.1 |

TABLE 12
GPC characterization of SBS copolymer produced in examples 12,
according with the invention, and in comparative examples C9, using
previous art.

| | Mp, | | |
|---|---|---|---|
| Example | kg/mol | Mw/Mn | MWD Shape |
| 12 | 109.8 | 1.03 | Unimodal narrow peak |
| C9 | 130.7 | 1.04 | Unimodal narrow peak |

Comparison of example 12, based on polar modifier system DTHFP/BDMAEE/SMT against comparative example C9, based on prior art polar modifier system TMEDA/SMT shows that invention polar modifier system conducts to higher 1,2-vinyl and much lower VCP repeat unit incorporation in the polybutadiene block than prior art when performed at high polymerization temperature. Moreover, butadiene polymerization spanned over a 44 to 61° C. temperature range in example 10, which is a more exigent condition (higher average polymerization temperature) than butadiene polymerization spanning in a range from 28 to 62° C. in comparative example C9. Both cases, invention and prior art conducted to unimodal narrow molecular weight distributions.

Comparative example C10. Uncoupled SBS block copolymerization using polar modifier system of prior art at high concentration, at high temperature range.

TABLE 13
Initiator and polar modifier system loadings, as well as overall solvent
to monomer (S/M) ratio in comparative example C10, using previous art.

| | BDMAEE, | Sodium tert-butoxide, | |
|---|---|---|---|
| | mol/ | mol/ | |
| Example | Li mol | Li mol | S/M |
| C10 | 0.95 | 0.35 | 8 |

TABLE 14
NMR characterization of SBS copolymer produced
in comparative example C10, using previous art.

| | Total | Block | Random | 1,2-vinyl, | VCP, | Total vinyl, | Total vinyl, |
|---|---|---|---|---|---|---|---|
| | Styrene, | styrene, | styrene, | wt %, | wt %, | 1,2 + VCP, | 1,2 + VCP, |
| Example | wt % | wt % | wt % | Bd basis | Bd basis | wt %, Bd basis | mol %, Bd basis |
| C10 | 26.4 | 25.3 | 1.1 | 77.7 | 8.3 | 86.0 | 81.5 |

TABLE 15
GPC characterization of SBS copolymer produced in
comparative example C10, using previous art.

| | Mp, | | |
|---|---|---|---|
| Example | kg/mol | Mw/Mn | MWD Shape |
| C10 | 986.6 | 9.47 | Tri-modal wide peak, |
| | | | Mp2 = 16.8 kg/mol |
| | | | Mp3 = 107.1 kg/mol |

Example 13 and 14. Uncoupled SBS block copolymerization using preferred polar modifier system of invention, at low monomer concentration level. An S-b-B-b-S type block copolymer was prepared in a lab scale batch reactor thru the following steps: (1) charge of cyclohexane solvent to a reactor; (2) stabilization of solvent to a temperature Ti; (3) charge of polar modifiers BDMAEE and DTHFP; (4) charge of n-butyllithium; (5) charge of SMT; (6) charge of styrene monomer; (7) immediate interruption of reactor temperature control to perform polymerization in absence of external cooling or heating, apart from natural heat loss to the surroundings (8) homopolymerization of first styrene block for a total time tSt, during which period heat of polymerization gradually raised reactor temperature up to a peak temperature TpSt at a time tpSt elapsed from beginning of styrene charge and such peak temperature; (10) registration of reactor temperature TiBd and immediate charge of butadiene monomer; (11) butadiene block copolymerization, where heat of reaction raised reactor temperature to a peak temperature TpBd which was registered, as well as time tpBd elapsed from beginning of butadiene charge to the moment TpBd occurred; (12) wait time of twBd past TpBd, where a slight temperature drop occurred; (13) charge of second styrene load; (14) polymerization of second polystyrene block until full consumption of styrene monomer; (15) charge of excess equivalents of an alcohol to assure termination of all polymer anions. In these formulations 2805 g of cyclohexane were used, 41.8 g of styrene were used to build polystyrene first block, 171.1 g of butadiene were used to build high vinyl polybutadiene middle block, and 41.8 g of styrene were used to build polystyrene end block. Thus, overall solvent to monomer ratio was 11.0. Feed time of each styrene load was 0.5 minutes long. Feed time for butadiene load was 2 minutes long. Active initiator content and polar modifier molar ratios to initiator are shown in Table 16. Process parameters Ti, TpSt, tpSt, tSt TiBd, TpBd, tpBd and twBd are listed in Table 17. SBS copolymer characterization of product from this example is shown in Table 18 and Table 19.

Comparative examples C11 and C12. Uncoupled SBS block copolymerization using polar modifier system of prior art, at low monomer concentration level: The same steps of procedure described in examples 10 and 11 were employed, but usage of DTHFP was avoided. In these formulations 4228 g of cyclohexane were used, 68.2 g of styrene were used to build polystyrene first block, 287.7 g of butadiene were used to build high vinyl polybutadiene middle block, and 68.2 g of styrene were used to build polystyrene end block. Thus, overall solvent to monomer ratio was 10.0. Active n-butyllithium and polar modifier system dosages for these comparative examples are reported in Table 16. Process parameters Ti, TpSt, tpSt, tSt, TiBd, TpBd and tpBd are listed in Table 17 for each comparative example. SBS copolymer characterization of products from these comparative examples is shown in Table 18 and Table 19.

TABLE 16
Initiator and polar modifier system loadings, as well as overall solvent to
monomer (S/M) ratio in examples 13 and 14, according with the invention,
and in comparative examples C11 and C12, using previous art.

| | n-BuLi, | DTHFP, | BDMAEE, | SMT, | |
|---|---|---|---|---|---|
| | mmol | mol/ | mol/ | mol/ | |
| Example | active | Li mol | Li mol | Li mol | S/M |
| 13 | 3.5 | 3.5 | 0.44 | 0.09 | 11 |
| 14 | 3.2 | 2.0 | 0.49 | 0.05 | 11 |
| C11 | 4.7 | 0 | 1.09 | 0.12 | 10 |
| C12 | 5.2 | 0 | 0.49 | 0.11 | 10 |

TABLE 17
Polymerization process parameters in examples 13
and 14, according with the invention, and in comparative
examples C11 and C12, using previous art.

| Exam- | Ti, | TpSt, | tpSt, | tSt, | Ti-Bd, | Tp-Bd, | tpBd, | twBd, |
|---|---|---|---|---|---|---|---|---|
| ple | ° C. | ° C. | min | min | ° C. | ° C. | min | min |
| 13 | 34.1 | 36.0 | 2 | 13 | 33.6 | 46.2 | 5 | 5 |
| 14 | 30.6 | 32.3 | 2 | 14 | 30.7 | 39.4 | 8 | 11 |
| C11 | 19.8 | 22.6 | 10 | 15 | 22.5 | 40.0 | 8 | 9 |
| C12 | 19.8 | N.D. | N.D. | 20 | 22.8 | 34.3 | 21 | 5 |

N.D. = Not detected

TABLE 18
NMR characterization of SBS copolymer produced in examples 13 and 14, according
with the invention, and comparative examples C11 and C12, using previous art.

| | Total | Block | Random | 1,2-vinyl, | VCP, | Total vinyl, | Total vinyl, |
|---|---|---|---|---|---|---|---|
| | Styrene, | styrene, | styrene, | wt %, | wt %, | 1,2 + VCP, | 1,2 + VCP, |
| Example | wt % | wt % | wt % | Bd basis | Bd basis | wt %, Bd basis | mol %, Bd basis |
| 13 | 33.3 | 31.8 | 1.5 | 84.0 | 4.7 | 88.6 | 86.4 |
| 14 | 33.9 | 31.6 | 2.3 | 84.0 | 3.8 | 87.8 | 85.9 |
| C11 | 31.9 | 30.5 | 1.4 | 86.8 | 5.1 | 91.9 | 89.4 |
| C12 | 30.9 | 21.0 | 9.9 | 88.2 | 2.1 | 90.3 | 89.2 |

TABLE 19
GPC characterization of SBS copolymer produced in examples 13 and
14, according with the invention, and in comparative examples Cl l and
C12, using previous art.

| | Mp, | | |
|---|---|---|---|
| Example | kg/mol | Mw/Mn | MWD Shape |
| 13 | 118.5 | 1.05 | Unimodal narrow peak |
| 14 | 129.1 | 1.05 | Unimodal narrow peak |
| C11 | 149.6 | 1.06 | Big shoulder at 121 kg/mol |
| C12 | 135.5 | 1.05 | Unimodal narrow peak |

FIG. 4. Molecular weight distribution of copolymer produced in examples 13 and 14. according with invention, and comparative examples C11 and C12, using prior art.

Analysis of examples 13 and 14, based on invention polar modifier system DTHFP/BDMAEE/SMT, shows that those where robust against lower monomer concentration during polymerization, producing high 1,2-vinyl and low VCP repeat unit contents in polybutadiene block, at high polymerization rate of styrene and butadiene blocks and with narrow unimodal molecular weight distribution in final product. On the other hand, employing prior art polar modifier system BDMAEE/SMT with polymerization at diluted monomer regime, conducted to bimodal weight distribution when BDMAEE/Li ratios was high, or to very slow polymerization rate and very high level of random styrene incorporation in the copolymer when BDMAEE/Li was low.

Examples 15 and 16. SB block copolymerization using preferred polar modifier system followed by coupling step. (S-b-B)n-X type copolymers were prepared in a lab scale stirred reactor using the following procedure: Cyclohexane (2792 g) was charged in to a stirred reactor under nitrogen atmosphere, and its temperature was stabilized at approximately 18° C. (Ti). Thereafter BDMAEE, DTHFP, n-butyllithium initiator and SMT were added to the reactor in the listed order. Active initiator content and polar modifier molar ratios to initiator are shown in Table 20. Then, styrene monomer (63.6 g) was charged to the reactor. Styrene feed operation was completed in 30 seconds. Reactor cooling was interrupted thereafter. It was registered a peak temperature (TpSt) for first styrene homo-polymerization stage as well as reaction time (tpSt) clapsed from beginning of first styrene load up to such moment. Then, a wait time of 10 minutes was practiced in both examples. Immediately afterwards reactor temperature was registered (Ti-Bd) and butadiene (246.1 g) feed operation began. Butadiene charge was completed in 2 minutes. Butadiene heat of polymerization raised reactant temperature, and when it reached 55.8±0.3° C. (TSiCl4) a shot of silicon tetrachloride coupling agent was fed to the reactor. Dosage of silicon tetrachloride (SiCl4) is shown in Table 20. Record was taken of butadiene reaction time up to coupling agent shot (tSiCl4), counted from start of butadiene feed operation. An alcohol solution shot, with hydroxyl equivalents in excess to n-butillithium initially fed to reactor, was fed to the reactor 6 minutes after SiCl4 shot. Cyclohexane to overall monomer feed ratio in these examples was 9.0. Process parameters Ti, TpSt, tpSt, TiBd, TSiCl4, tSiCl4 are listed in Table 21. SBS copolymer characterization of product from this example is shown in Table 22 and Table 23.

Comparative examples C13 and C14, using prior art. The same polymerization procedure as in examples 15 and 16 was performed, but polar modifier system lacked DTHFP. Active initiator content, polar modifier molar ratios to initiator, and silicon chloride dosage are shown in Table 20. Process parameters Ti, TpSt, tpSt, TiBd and tSiCl4 are listed in Table 21. SBS copolymer characterization of product from this example is shown in Table 22 and Table 23.

TABLE 20
Initiator, polar modifier system, and coupling agent loadings in
examples 15 and 16, according with the invention, and comparative
examples C13 and C14, using previous art.

| | n-BuLi, | DTHFP, | BDMAEE, | SMT, | |
|---|---|---|---|---|---|
| | mmol | mol/ | mol/ | mol/ | SiCl₄, |
| Example | active | Li mol | Li mol | Li mol | mmol |
| 15 | 4.5 | 2.7 | 0.76 | 0.06 | 1.09 |
| 16 | 4.8 | 2.5 | 0.71 | 0.05 | 1.16 |
| C13 | 4.5 | 0 | 0.76 | 0.06 | 1.09 |
| C14 | 4.5 | 0 | 0.96 | 0.06 | 1.09 |

TABLE 21
Polymerization process parameters in examples 15
and 16, according with the invention, and comparative
examples C13 thru C14, using previous art.

| | Ti, | TpSt, | tpSt, | TiBd, | TSiCl4, | tSiCl4, |
|---|---|---|---|---|---|---|
| Example | ° C. | ° C. | min | ° C. | ° C. | min |
| 15 | 18.1 | 23.1 | 7.0 | 22.8 | 56.0 | 6.7 |
| 16 | 18.1 | 23.1 | 7.5 | 22.9 | 55.9 | 6.9 |
| C13 | 18.3 | 23.4 | 28.0 | 23.4 | 55.5 | 13.0 |
| C14 | 18.3 | 23.4 | 17.0 | 23.2 | 56.1 | 9.5 |

TABLE 22
NMR characterization of SBS copolymer produced in examples 15 and 16, according
with the invention, and in comparative examples C13 and C14, using previous art.

| | Total | Block | Random | 1,2-vinyl, | VCP, | Total vinyl, | Total vinyl, |
|---|---|---|---|---|---|---|---|
| | Styrene, | styrene, | styrene, | wt %, | wt %, | 1,2 + VCP, | 1,2 + VCP, |
| Example | wt % | wt % | wt % | Bd basis | Bd basis | wt %, Bd basis | mol %, Bd basis |
| 15 | 21.2 | 20.9 | 0.3 | 85.9 | 3.4 | 89.4 | 87.7 |
| 16 | 21.2 | 20.9 | 0.3 | 85.8 | 3.5 | 89.2 | 87.5 |
| C13 | 21.5 | 21.2 | 0.3 | 86.5 | 3.8 | 90.2 | 88.4 |
| C14 | 21.7 | 21.4 | 0.2 | 86.2 | 4.0 | 90.2 | 88.2 |

TABLE 23
GPC characterization of SBS copolymer produced in examples 15 and
16, according with the invention, and in comparative examples C13 thru
C14, using previous art.

| | | Coupled SBS |
|---|---|---|
| | Mp_{uc}, | copolymer, |
| Example | kg/mol | wt % |
| 15 | 119.7 | 79.9 |
| 16 | 111.9 | 85.3 |
| C13 | 127.1 | 44.7 |
| C14 | 118.1 | 51.5 |

Mp_{uc} = Peak molecular weight of un-coupled fraction.

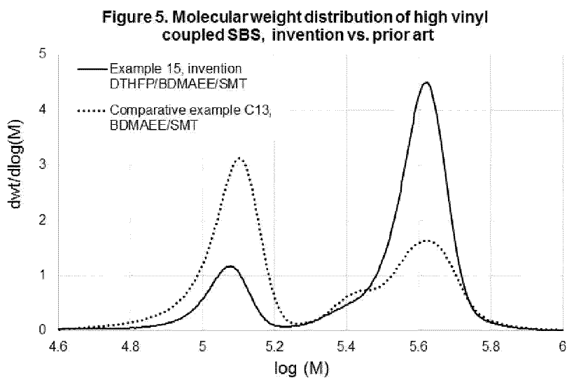

FIG. 5. Molecular weight distribution of copolymer produced in example 15, according with invention, and comparative example C13, using prior art.

When comparing coupling efficiency and molecular weight distribution obtained with polar modifier of invention DTHFP/BDMAEE/SMT, used in example 15 and 16, against such parameters when using prior art based on polar modifier system BDMAEE/SMT, as in comparative examples C13 and C14, it can be evidenced that invention polar modifier system provides livingness to much higher amount of polymer anions up to end of butadiene consumption than closest prior polar modifier system does. SiCl4 load was planned for a theoretical maximum coupling efficiency of 95% to 96% if every polymer anion would remain alive when SiCl4 charge occurred. In comparative examples C13 and C14 about half of polymeric anions were unable to participate in the coupling reaction, confirming that about half of polymeric anions had terminated before SiCl4 charge. It is worthwhile to notice that cyclohexane, styrene and butadiene loadings of these examples agreed with cyclohexane, first styrene and butadiene loadings of Example 3 thru 11 and comparative examples C7 and C8. Therefore, livingness of polymer anions up to the end of butadiene consumption evidenced in examples 15 and 16 applies to examples 3 thru 11, that shared preferred polar modifier system DTHFP/BDMAEE/SMT and obtained unimodal narrow molecular weight distributed un-coupled SBS product. On the other hand, same degree of premature termination of polymer anions evidenced in comparative examples C13 and C14 applies for comparative examples C7 and C8, all of them using closest prior art system BDMAEE/SMT, and showing wide bimodal molecular weight distributions.

Example 17. Linear high vinyl SBS block copolymer synthesized using preferred polar modifier system of this invention, further hydrogenated to obtain a linear high vinyl SEBS block copolymer.

A precursor (i.e., linear high vinyl SBS block copolymer) was first synthesized at lab scale using a stirred batch reactor without using any thermal insulation level. First, cyclohexane (8739 g) was charged into the reactor under nitrogen atmosphere. The initial temperature was 21.9° C. (Ti). Thereafter, BDMAEE, DTHFP, SMT were added to the reactor in the listed order. Then, the first half of styrene monomer (160 ml) and the n-butylithium initiator were added. The styrene polymerization reaction was carried out without any cooling system. The styrene temperature peak was 23.8° C. (TpSt1) and was detected after 9 minutes of operation (tpSt1). After 10 minutes when the temperature was 22.9° C. (TiBd), the butadiene was feed (945 ml), raising the temperature until 47.1° C. (TpBd). After a wait period of 30 minutes (twBd), the second half of the styrene was added (160 ml). The styrene polymerization was completed in 10 minutes and then, an alcohol was added to terminate the anionic polymer anions and obtain the precursor. Afterwards, the linear high vinyl SBS block copolymer was hydrogenated using a state of the art catalyst as disclosed in U.S. Pat. No. 5,321,175 (20 ml) raising up the temperature until 125° C. (TiH2) followed by hydrogen addition. The hydrogenation was completed in 100 minutes to obtain a linear high vinyl SEBS block copolymer. Process parameters Ti, TpSt1, tpSt1, TiBd, TpBd, TwBd and TiH2 are listed in Table 25. The linear high vinyl SEBS block copolymer characterization is shown in Tables 26 and 27. The linear high vinyl SEBS block copolymers were characterized by MFI, and by Brookfield viscosity. The results are shown in Table 28.

Comparative example C15 using prior art. The precursor was first synthesized at lab scale using a stirred batch reactor. First, cyclohexane (8739 g) was charged into the reactor under nitrogen atmosphere. The initial temperature was 56.0° C. (Ti). Thereafter, DTHFP were added to the reactor as unique polar modifier. Then, the first half of styrene monomer (160 ml) and the n-butylithium initiator were added. The styrene temperature peak was 56.4° C. (TpSt1) and was detected after 3 minutes of operation (tpSt1). After 10 minutes when the temperature was 54.6° C. (TiBd), the butadiene was feed (945 ml), raising the temperature until 86.7° C. (TpBd). After a wait period of 30 minutes (twBd), the second half of the styrene was added (160 ml). The styrene polymerization was taken in 10 minutes and then, an alcohol was added to terminate the anionic polymer anions. Afterwards, the block copolymer was hydrogenated using a state of the art catalyst as disclosed in U.S. Pat. No. 5,321,175 (20.5 ml) raising up the temperature until 125° C. (TiH2) followed by hydrogen addition. The hydrogenation was completed in 150 minutes. Process parameters Ti, TpSt1, TiBd, TpBd, TwBd and TiH2 are listed in Table 25. SEBS hydrogenated copolymer characterization of product of this example in shown in Table 26 and 27. The hydrogenated block copolymers were not only characterized by MFI, but also by the Brookfield viscosity.

The results in Tables 27 and 28 show that the inventive example 17 has higher MFI and lower viscosity despite having higher Mp than the comparative example C15.

TABLE 24
Initiator and polar modifier system loading, as well as overall solvent
to monomer (S/M) ratio of example 17 according with the invention,
and comparative example C15 using prior art.

| | n-BuLi, | DTHFP, | BDMAEE, | SMT, | |
|---|---|---|---|---|---|
| | mmol | mol/ | mol/ | mol/ | |
| Example | active | Li mol | Li mol | Li mol | S/M |
| 17 | 11.6 | 2.40 | 0.76 | 0.06 | 9.9 |
| C15 | 14.7 | 0.65 | 0 | 0 | 10.1 |

TABLE 25
Polymerization process parameters of example 17 according with the
invention, and comparative example C15 using prior art.

| | Ti, | TpSt1, | tpSt1, | TiBd, | TpBd, | TwBd, | TiH2, |
|---|---|---|---|---|---|---|---|
| Example | º C. | º C. | min. | º C. | º C. | min | º C. |
| 17 | 21.9 | 23.8 | 9 | 22.9 | 47.1 | 30 | 125 |
| C15 | 56.0 | 56.4 | 3 | 54.6 | 86.7 | 30 | 125 |

TABLE 26
NMR characterization of linear high vinyl SEBS copolymer of
example 17 according with the invention, and comparative example C15 using prior art.

| | | | | | | | Total vinyl, | |
|---|---|---|---|---|---|---|---|---|
| | Total | Block | Random | 1,2-vinyl, | VCP, | Total vinyl, | 1,2 + VCP, | BdH |
| | Styrene, | styrene, | styrene, | wt %, | wt %, | 1,2 + VCP, | mol %, Bd | wt %, |
| Example | wt % | wt % | wt % | Bd basis | Bd basis | wt %, Bd basis | basis | Bd basis |
| 17 | 14.3 | 12.4 | 1.9 | 83.7 | 2.4 | 86.1 | 86.0 | 99.4 |
| C15 | 14.7 | 12.8 | 1.9 | 61.3 | 2.5 | 63.8 | 63.4 | 96.7 |

TABLE 27
GPC characterization of linear high vinyl SEBS copolymer of
example 17 according with the invention, and comparative
example C15 using prior art.

| | Mp | Mw/Mn | |
|---|---|---|---|
| Example | kg/mol | kg/mol | MWD Shape |
| 17 | 156.5 | 1.03 | Unimodal narrow peak |
| C15 | 136.7 | 1.12 | Unimodal narrow peak |

TABLE 28
Characterization of linear high vinyl SEBS copolymer of
example 17 according with the invention, and
comparative example C15 using prior art.

| | MFI, | Brookfiled viscosity, |
|---|---|---|
| Example | (g/10 min) | (cP) |
| 17 | 27.3 | 12.4 |
| C15 | 19.2 | 22.4 |

Example 18. Coupled high vinyl SBS block copolymer using preferred polar modifier system of the invention: further hydrogenated to obtain a star-type or radial high vinyl SEBS block copolymer.

A precursor (i.e., radial high vinyl SBS block copolymer or (S-B)n-X) was first synthesized at lab scale using a stirred batch reactor without using any thermal insulation level. First, cyclohexane (8956 g) was charged into the reactor under nitrogen atmosphere. The initial temperature was 19.2° C. (Ti). Thereafter, BDMAEE, DTHFP, SMT were added to the reactor in the listed order. Then, the styrene monomer (431 ml) and the n-butylithium initiator were added. The styrene polymerization reaction was carried out without any cooling system. The styrene temperature peak was 25.4° C. (TpSt1) and was detected after 4 minutes of operation (tpSt1). After 10 minutes when the temperature was 21.5° C. (TiBd), the butadiene was feed (889 ml), raising the temperature until 58° C. (TpBd). Then, a coupling agent (MeSiCl3) was added to induce the coupling reaction. After a wait period of 10 minutes, an alcohol was added to terminate the anionic polymer anions and obtain the precursor. Afterwards, the radial high vinyl SBS block copolymer was hydrogenated using a state of the art catalyst as disclosed in U.S. Pat. No. 5,321,175 (20 ml) raising up the temperature until 125° C. (TiH2) followed by hydrogen addition. The hydrogenation was completed in 100 minutes to obtain a radial high vinyl SEBS block copolymer or (S-EB)n-X. Process parameters Ti, TpSt1, tpSt1, TiBd, TpBd and TiH2 are listed in Table 29. The radial high vinyl SEBS block copolymer characterization is shown in Tables 30 and 31. The radial high vinyl SEBS block copolymer were not only characterized by MFI, but also by the Brookfield viscosity. The results are shown in Table 33.

Comparative example C16 using prior art. The precursor was first synthesized at lab scale using a stirred batch reactor without using any thermal insulation level. First, cyclohexane (8956 g) was charged into the reactor under nitrogen atmosphere. The initial temperature was 28.4° C. (Ti). Thereafter, DTHFP was added to the reactor. Then, the styrene monomer (431 ml) and the n-butylithium initiator were added. The styrene temperature peak was 35.8° C. (TpSt1) and was detected after 3 minutes of operation (tpSt1). After 10 minutes when the temperature was 32.6° C. (TiBd), the butadiene was feed (889 ml), raising the temperature until 60.6° C. (TpBd). Then, the coupling agent (MeSiCl3) was added to induce the coupling reaction. After a wait period of 10 minutes, an alcohol was added to terminate the anionic polymer anions. Afterwards, the block copolymer was hydrogenated using a state of the art catalyst as disclosed in U.S. Pat. No. 5,321,175 (13 ml) raising up the temperature until 125° C. (TiH2) followed by hydrogen addition. The hydrogenation was completed in 100 minutes. Process parameters Ti, TpSt1, tpSt1, TiBd, TpBd and TiH2 are listed in Table 29. SEBS hydrogenated copolymer characterization of product of this example in shown in Table 30 and 31. The hydrogenated block copolymers were not only characterized by MFL, but also by the Brookfield viscosity.

TABLE 29
Initiator and polar modifier system loading, as well as overall solvent
to monomer (S/M) ratio of example 18 according with the invention, and
comparative example C16 using prior art.

| | n-BuLi, | DTHFP, | BDMAEE, | SMT, | | MeSiCl₃, |
|---|---|---|---|---|---|---|
| | mmol | mol/ | mol/ | mol/ | | mol/ |
| Example | active | Li mol | Li mol | Li mol | S/M | Li mol |
| 18 | 42.9 | 1.92 | 0.68 | 0.05 | 9.7 | 0.40 |
| C16 | 39.6 | 1.10 | 0 | 0 | 9.9 | 0.43 |

TABLE 30
Polymerization process parameters of example 18 according with the
invention, and comparative example C16 using prior art.

| | Ti, | TpSt1, | tpSt1, | TiBd, | TpBd, | TiH₂, |
|---|---|---|---|---|---|---|
| Example | º C. | º C. | min. | º C. | º C. | º C. |
| 18 | 19.2 | 25.4 | 4 | 21.5 | 58.0 | 125 |
| C16 | 28.4 | 35.8 | 3 | 32.6 | 60.6 | 125 |

TABLE 31
NMR characterization of radial high vinyl SEBS copolymer of
example 18 according with the invention, and comparative example C16 using prior art.

| | Total | Block | Random | 1,2-vinyl, | VCP, | Total vinyl, | Total vinyl, | BdH |
|---|---|---|---|---|---|---|---|---|
| | Styrene, | styrene, | styrene, | wt %, | wt %, | 1,2 + VCP, | 1,2 + VCP, | wt %, |
| Example | wt % | wt % | wt % | Bd basis | Bd basis | wt %, Bd basis | mol %, Bd basis | Bd basis |
| 18 | 19.5 | 19.3 | 0.2 | 81.9 | 4.2 | 86.1 | 85.9 | 98.5 |
| C16 | 19.5 | 19.2 | 0.3 | 77.1 | 2.9 | 80.0 | 79.7 | 96.9 |

TABLE 32
GPC characterization of radial high vinyl SEBS copolymer of
example 18 according with the invention, and comparative
example C16 using prior art.

| | Mp | Coupling | | |
|---|---|---|---|---|
| | coupled | degree | Mw/Mn | |
| Example | kg/mol | (%) | kg/mol | MWD Shape |
| 18 | 38.9 | 86.8 | 1.19 | Bimodal narrow peaks |
| C16 | 42.1 | 88.7 | 1.08 | Bimodal narrow peaks |

TABLE 33
Characterization of radial high vinyl SEBS copolymer of
example 17 according with the invention, and
comparative example C15 using prior art.

| | MFI, | Brookfiled viscosity, |
|---|---|---|
| Example | (g/10 min) | (cP) |
| 18 | 170 | 6.0 |
| C16 | 385 | 6.8 |

Example 19: The linear high vinyl SEBS block copolymer from example 17and comparative example C15 were compounded with polypropylene (ISPLEN PR590 from Repsol) at 50% by weight (relative to the total compound) using an internal mixer at 190° C. during 15 minutes. Then, the compounds were compression-molded at 190° C. to obtain the specimens to test the mechanical properties. The tensile properties and the hardness were tested according to ASTM D412, and the results are shown in Table 32. Surprisingly, the inventive thermoplastic elastomer (TPE) composition prepared with the linear high vinyl SEBS block copolymer of example 17 showed higher tensile strength and elongation at break with higher MFI compared with the compound prepared with the SEBS of comparative example C15, thus, an unexpected better balance of mechanical and flow properties of the TPE composition was achieved.

TABLE 34
Mechanical properties of SEBS/PP compounds of
example 17 according with the invention, and
comparative example C15 using previous art.

| | | | Max. Stress | Max. |
|---|---|---|---|---|
| | Polymer | MFI, | at break, | Elongation, |
| Example | blend | (g/10 min) | (MPa) | (%) |
| 17 | 1 | 34.2 | 13.6 | 780 |
| C15 | 2 | 30.4 | 8.8 | 340 |

Example 20 (Hypothetical). Linear SBS block copolymer of example 10 synthesized using preferred polar modifier system of this invention, further subjected to end-functionalization and further subjected to hydrogenation to obtain a linear high vinyl end-functionalized SEBS-f.

Linear SBS from example 8 exhibiting 90.1 wt % total vinyl content and still dissolved in cyclohexane (solvent to polymer ratio 8.0, w/w) was end-functionalized with OH or secondary amine functional groups by adding quantitative amounts of either propylene oxide or n-benzylidenemethylamine (molar ratio functionalization agent/Li active=1.0). Thereafter, polymer solution was heated up to 90° C. and 0.25 mmol of hydrogenation catalyst (Cp2 Ti(PhOCH3)2 or Cp2 Ti (CH2 PPh2) as described in U.S. Pat. No. 5,985,995A) per 100 g of polymer were added, followed by hydrogen addition up to a pressure of 8 kg/cm2 was reached. Hydrogen uptake was completed in 45 minutes. As revealed by 1H NMR analysis, it was obtained an end-functionalized SEBS-f having 99.6% hydrogenation. Therefore, novel linear SEBS-OH or SEBS-NHR derived from a linear SBS having 90.1 wt % vinyl content were thus obtained.

End-functionalized SEBS from example 20 are new materials exhibiting OH or amine polar groups combined with high butylene enrichment along the central EB block. These novel materials are useful as reactive polymers to effect chain-extension reactions useful to produce novel segmented block copolymers and to be used more efficiently in engineering plastics impact modification and polymer blends compatibilization.

### EMBODIMENTS OF THE INVENTION

Embodiment 1. A polar modifier system for making block copolymers of vinyl aromatic monomers and conjugated diene monomers by organolithium initiated anionic polymerization, comprising:
(a) a compound having the structure of formula (I):

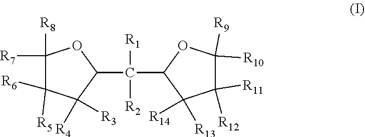

wherein R₁ thru R₁₄ independently are —H or —CₙH₂ₙ₊₁ groups, wherein n=1 to 6, and
wherein ditetrahydrofurfurylpropane (DTHFP) is a preferred compound that has the structure of formula (I).
(b) a compound having the structure of formula (V):

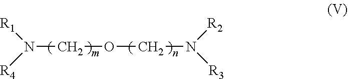

wherein m=1 to 2, n=1 to 2; and
wherein R₁ to R₄ independently are —CₓH₂ₓ₊₁ groups, wherein x=1 to 6, and
wherein bis[2-(N,N-dimethylamino)ethyl] ether is a preferred compound that has the structure of formula (V); and
(c) a sodium alkoxide compound, preferably sodium mentholate
wherein the molar ratio of ditetrahydrofurfurylpropane to the organolithium initiator is within the range of about 0.36:1 to about 4.2:1, preferably about 1.5:1 to about 3.5:1 and more preferably about 2.5:1 to about 3.0;
wherein the molar ratio of bis[2-(N,N-dimethylamino)ethyl] ether to the organolithium initiator is within the range of about 0.1:1 to about 1.5:1, or about 0.2:1 to about 1:1, preferably about 0.3:1 to about 1:1, more preferably about 0.4:1 to about 0.9:1;
wherein the molar ratio of sodium alkoxide compound to the organolithium initiator is within the range of about 0.01:1 to about 0.3:1, or about 0.02:1 to about 0.2:1, or preferably about 0.03:1 to about 0.15:1, or more preferably about 0.04:1 to about 0.10:1.

Embodiment 2. A polar modifier system for making block copolymers of vinyl aromatic monomers and conjugated diene monomers by organolithium initiated anionic polymerization, comprising:
(a) a compound having the structure of formula (II):

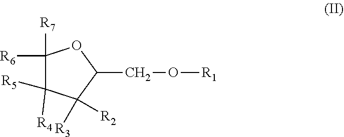

wherein R1 is a —CₙH₂ₙ₊₁ group, wherein n=1 to 6; and
wherein R2 thru R7 independently are —H or —CₓH₂ₓ₊₁ groups, wherein x=1 to 6.
(b) a compound having the structure of formula (V):

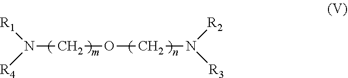

wherein m=1 to 2, n=1 to 2; and
wherein R₁ to R₄ independently are —CₓH₂ₓ₊₁ groups, wherein x=1 to 6, and
wherein bis[2-(N,N-dimethylamino)ethyl] ether is a preferred compound that has the structure of formula (V); and
(c) a sodium alkoxide compound, preferably sodium mentholate,
wherein the molar ratio of ethyltetrahydrofurfuryl ether to the organolithium initiator is within the range of about 0.3:1 to about 4:1, preferably about 1:1 to about 3:1 and more preferably about 1.5:1 to about 2.5:1,
wherein the molar ratio of bis[2-(N,N-dimethylamino)ethyl] ether to the organolithium initiator is within the range of about 0.1:1 to about 1.5:1, or about 0.2:1 to about 1:1, preferably about 0.3:1 to about 1:1, more preferably about 0.4:1 to about 0.9:1;
wherein the molar ratio of sodium alkoxide compound to the organolithium initiator is within the range of about 0.01:1 to about 0.3:1, or about 0.02:1 to about 0.2:1, or preferably about 0.03:1 to about 0.15:1, or more preferably about 0.04:1 to about 0.10:1.

Embodiment 3. A polar modifier system for making block copolymers of vinyl aromatic monomers and conjugated diene monomers by organolithium initiated anionic polymerization, comprising:
(a) a compound having the structure of formula (III):

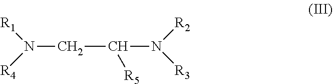

wherein R₁ to R₄ independently are —CH₃ or —CH₂CH₃ groups; and
wherein R₅ is a —H or a —CₙH₂ₙ₊₁ group, wherein n=1 to 2, and
wherein N,N,N′,N′-tetramethyl ethylenediamine is a preferred compound that has the structure of formula (III).
(b) a compound having the structure of formula (V):

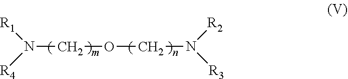

wherein m=1 to 2, n=1 to 2; and
wherein R₁ to R₄ independently are —CₓH₂ₓ₊₁ groups, wherein x=1 to 6, and
wherein bis[2-(N,N-dimethylamino) ethyl] ether is a preferred compound that has the structure of formula (V); and
(c) a sodium alkoxide compound, preferably sodium mentholate,
wherein the molar ratio of N,N,N′, N′-tetramethyl ethylenediamine to the organolithium initiator is within the range of about 1:1 to about 4:1, preferably about 1.5:1 to about 3:1 and more preferably about 2:1 to about 3:1,
wherein the molar ratio of bis[2-(N,N-dimethylamino) ethyl] ether to the organolithium initiator is within the range of about 0.1:1 to about 1.5:1, or about 0.2:1 to about 1:1, preferably about 0.3:1 to about 1:1, more preferably about 0.4:1 to about 0.9:1;
wherein the molar ratio of sodium alkoxide compound to the organolithium initiator is within the range of about 0.01:1 to about 0.3:1, or about 0.02:1 to about 0.2:1, or preferably about 0.03:1 to about 0.15:1, or more preferably about 0.04:1 to about 0.10:1.

Embodiment 4. A polar modifier system for making block copolymers of vinyl aromatic monomers and conjugated diene monomers by organolithium initiated anionic polymerization, comprising:
(a) a compound having the structure of formula (IV):

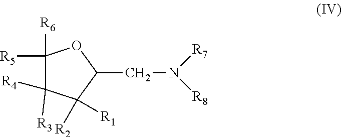

wherein R₁ to R₆ independently are —H or —CₙH₂ₙ₊₁ groups, wherein n=1 to 6;
wherein R₇ and R₈ independently are —CₓH₂ₓ₊₁ groups, wherein x=1 to 2, and
wherein tetrahydrofurfuryl-N,N-dimethylamine is a preferred compound that has the structure of formula (IV).
(b) a compound having the structure of formula (V):

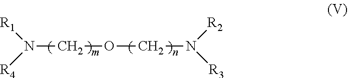

wherein m=1 to 2, n=1 to 2; and
wherein R₁ to R₄ independently are —CₓH₂ₓ₊₁ groups, wherein x=1 to 6, and
wherein bis[2-(N,N-dimethylamino) ethyl] ether is a preferred compound that has the structure of formula (V); and
(c) a sodium alkoxide compound, preferably sodium mentholate,
wherein the molar ratio of tetrahydrofurfuryl-N,N-dimethylamine to the organolithium initiator is within the range of about 1:1 to about 4:1, preferably about 1.5:1 to about 3:1 and more preferably about 2:1 to about 3:1,
wherein the molar ratio of bis[2-(N,N-dimethylamino)ethyl] ether to the organolithium initiator is within the range of about 0.1:1 to about 1.5:1, or about 0.2:1 to about 1:1, preferably about 0.3:1 to about 1:1, more preferably about 0.4:1 to about 0.9:1;
wherein the molar ratio of sodium alkoxide compound to the organolithium initiator is within the range of about 0.01:1 to about 0.3:1, or about 0.02:1 to about 0.2:1, or preferably about 0.03:1 to about 0.15:1, or more preferably about 0.04:1 to about 0.10:1.

Having described the invention above, various modifications of the techniques, procedures, materials, and equipment will be apparent to those skilled in the art. It is intended that all such variations within the scope and spirit of the invention be included within the scope of the appended claims.

What is claimed is:

1. A styrenic block copolymer composition comprising at least one high vinyl block copolymer selected from the group consisting of:
(i) a block copolymer having the formula:
(S—B)n-S, (B—S)n-B, or (S—B)n,
wherein S is a vinyl aromatic polymer block,
wherein S content in the block copolymer is from 10 to 40 wt %,
wherein randomized vinyl aromatic repeat unit content is less than 15 wt % based on total vinyl aromatic content,
wherein B is a conjugated diene polymer block,
wherein the B block has a vinyl content of more than 85 mol % on a conjugated diene repeat unit basis, including 1,2-vinyl, 3,4-vinyl and vinylcyclopentane (VCP) repeat units,
wherein n is a value from 1 to 5, and
wherein the GPC peak molecular weight Mp of the block copolymer relative to polystyrene standards is from 50 to 300 kg/mol;
(ii) a block copolymer having the formula:
[(S—B)m-S]n-X, [(B—S)m-B]n-X, [(S—B)m]n-X, or [(B—S)m]n-X,
wherein S is a vinyl aromatic polymer block,
wherein S content in the block copolymer is from 10 to 40 wt %,
wherein randomized vinyl aromatic repeat unit content is less than 15 wt % based on total vinyl aromatic content,
wherein B is a conjugated diene polymer block,
wherein the B block has a vinyl content of more than 85 mol % on a conjugated diene repeat unit basis, including 1,2-vinyl, 3,4-vinyl and vinylcyclopentane (VCP) repeat units,
wherein m is a value from 1 to 3,
wherein n is a value from 2 to 30,
wherein X is the residue of a coupling agent, and
wherein the GPC peak molecular weight Mp of the block copolymer relative to polystyrene standards is from 50 to 480 kg/mol; and
(iii) a block copolymer having the formula:
(S—B)n-S-f, (B—S)n-B-f, [(S—B)n]-f or [(B—S)n]-f,
wherein S is a vinyl aromatic polymer block,
wherein S content in the block copolymer is from 10 to 40 wt %,
wherein randomized vinyl aromatic repeat unit content is less than 15 wt % based on total vinyl aromatic content,
wherein B is a conjugated diene polymer block,
wherein the B block has a vinyl content of more than 85 mol % on a conjugated diene repeat unit basis, including 1,2-vinyl, 3,4-vinyl and vinylcyclopentane (VCP) repeat units,
wherein n is a value from 1 to 5,
wherein f is an end group with an —OH or a secondary amine moiety, and
wherein the GPC peak molecular weight Mp of the block copolymer relative to polystyrene standards is from 50 to 300 kg/mol;
wherein the block copolymer composition comprises a VCP content of less than 6 wt % on a total conjugated diene basis.

2. Elastic films, fibers or non-woven materials comprising the styrenic block copolymer composition of claim 1, wherein the high vinyl block copolymer is or is not hydrogenated.

3. An oil-gel composition comprising the styrenic block copolymer composition of claim 1, wherein the high vinyl block copolymer is or is not hydrogenated.

4. A sealant formulation comprising the styrenic block copolymer composition of claim 1, wherein the high vinyl block copolymer is or is not hydrogenated.

5. A compounded material comprising the styrenic block copolymer composition of claim 1, wherein the high vinyl block copolymer is or is not hydrogenated.

6. A polypropylene composition with oxygen-absorbing capability comprising the styrenic block copolymer composition of claim 1, wherein the high vinyl block copolymer is or is not hydrogenated.

7. A radiation-curable hot-melt adhesive composition comprising an adhesive formulation and the styrenic block copolymer composition of claim 1, wherein the high vinyl block copolymer is or is not hydrogenated.

8. A hot-melt pressure-sensitive adhesive composition comprising an adhesive formulation and the styrenic block copolymer composition of claim 1, wherein the high vinyl block copolymer is or is not hydrogenated.

9. A piezoresistive ink composition comprising the styrenic block copolymer composition of claim 1, wherein the high vinyl block copolymer is or is not hydrogenated.

10. A binder for lithium-ion batteries comprising the styrenic block copolymer composition of claim 1, wherein the high vinyl block copolymer is or is not hydrogenated.

11. An article of manufacture comprising the styrenic block copolymer composition of claim 1, wherein the styrenic block copolymer composition has been injection molded to form the article of manufacture, and wherein the high vinyl block copolymer is or is not hydrogenated.

12. A thermoplastic elastomer (TPE) composition comprising the compounded material of claim 5 and a thermoplastic resin.

13. The TPE composition of claim 12, wherein the thermoplastic resin is selected from the group consisting of polystyrene, polypropylene, polyethylene, ethylene/α-olefin copolymer, ethylene/propylene copolymer, ethylene/propylene/diene terpolymer, propylene/1-butene copolymer, propylene/ethylene/α-olefin terpolymer, impact propylene/ethylene copolymer, and recycled equivalents of the polyolefin-based polymer, including post-consumer and/or post-industrial recycling materials, or a mixture of the foregoing.

14. The TPE composition of claim 12, wherein the high vinyl block copolymer is hydrogenated.

15. The TPE composition of claim 14, wherein the thermoplastic resin is a polyolefin-based polymer.

16. The TPE composition of claim 15, wherein the polyolefin-based polymer is selected from the group consisting of polypropylene, polyethylene, ethylene/α-olefin copolymer, ethylene/propylene copolymer, ethylene/propylene/diene terpolymer, propylene/1-butene copolymer, propylene/ethylene/α-olefin terpolymer, impact propylene/ethylene copolymer, and recycled equivalents of the polyolefin-based polymer, including post-consumer and/or post-industrial recycling materials, or a mixture of the foregoing.

17. The TPE composition of claim 16, comprising at least 50 wt. % of polypropylene based on the total weight of the TPE composition.

18. The TPE composition of claim 12, wherein the amount of thermoplastic resin is between 10 and 100 phr, wherein “phr” means parts per hundred of the styrenic block copolymer composition, and wherein the high vinyl block copolymer is hydrogenated.

19. The TPE composition of claim 18, wherein the TPE composition has a melt flow rate (MFR) between 5 and 50, preferably between 10 and 40, more preferably between 15 and 35, wherein the MFR (g/10′) is measured at 230° C. and 2.16 kg.

20. The TPE composition of claim 18, wherein the TPE composition has a tensile strength at room temperature, higher than 9 MPa, preferably higher than 11 MPa, more preferably higher than 13 MPa.

21. The TPE composition of claim 18, wherein the TPE composition has a maximum elongation at room temperature higher than 400%, preferably higher than 600%, more preferably higher than 700%.

22. The TPE composition of claim 18, wherein the TPE composition has compression resistance at temperatures between 20° C. and 100° C.

23. A medical article or device comprising the TPE composition of claim 18.

24. A compressed molded article comprising the TPE composition of claim 18.

25. An article of manufacture comprising the TPE composition of claim 18, wherein the TPE composition has been injection molded to form the article of manufacture.
